(19) United States
(12) Patent Application Publication
(10) Pub. No.: US 2018/0057685 A1
(43) Pub. Date: Mar. 1, 2018

(54) FLAME-RETARDANT RESIN COMPOSITION

(71) Applicant: ASAHI KASEI KABUSHIKI KAISHA, Tokyo (JP)

(72) Inventors: Chihiro MAEDA, Tokyo (JP); Mihoko YAMAMOTO, Tokyo (JP); Akira MITSUI, Tokyo (JP)

(73) Assignee: ASAHI KASEI KABUSHIKI KAISHA, Tokyo (JP)

(21) Appl. No.: 15/627,765

(22) Filed: Jun. 20, 2017

(30) Foreign Application Priority Data
Aug. 31, 2016 (JP) 2016-170193

(51) Int. Cl. C08L 71/10; C07F 9/6581; C08L 23/12; C08L 25/06; C08L 77/00

(52) U.S. Cl. CPC C08L 71/10; C07F 9/65812; C08L 2201/02; C08L 25/06; C08L 77/00; C08L 23/12

(57) ABSTRACT

Provided is a resin composition having excellent flame retardance, molding processability, and post-heat aging flame retardance. A flame-retardant resin composition contains: (A) a polyphenylene ether; (B) at least one thermoplastic resin selected from the group consisting of (B-1) a polystyrene resin, (B-2) a polyamide resin, (B-3) a polypropylene resin, and (B-4) a polyphenylene sulfide resin; and (C) a flame retardant. The (A) component has a content of less than 50 mass % when the flame-retardant resin composition minus ash content is taken to be 100 mass %. The flame-retardant resin composition has a flame retardance level of V-0 as measured by a UL 94 vertical burning test. A molded article formed from the flame-retardant resin composition exhibits a rate of change of chloroform-insoluble content of no greater than 15 mass % before and after being subjected to aging in which the molded article is left for 1,000 hours at 150° C. in an atmospheric environment.

### TECHNICAL FIELD

The present disclosure relates to a flame-retardant resin composition.

### BACKGROUND

Polyphenylene ether (hereinafter, also referred to as “PPE”) resin compositions based on polyphenylene ether resins have features such as heat resistance, electrical properties, dimensional stability, impact resistance, and low specific gravity.

Moreover, since it is possible to provide polyphenylene ether resin compositions with flame retardance without the need to use halogen-containing compounds and antimony compounds that have a high environmental burden, polyphenylene ether resin compositions are used in a wide range of applications such as various electric and electronic components, office equipment components, vehicle components, building materials, and other exterior materials and industrial goods.

In recent years, progress toward more compact and higher performance components has resulted in demand for favorable long-term properties in addition to short-term properties. Consequently, there is demand for mechanical strength and flame retardance that are maintained even upon long-term exposure to a high-temperature environment.

Currently known methods for raising heat stability of polyphenylene ethers include addition of antioxidants and terminal stabilization through use of vinyl compounds (refer to PTL 1-4).

### CITATION LIST

### Patent Literature

PTL 1: WO 2012/176798 A1

PTL 2: JP 2012-153832 A

PTL 3: JP 4322394 B2

PTL 4: JP 2925646 B2

### SUMMARY

The inventors discovered a problem that although PPE resin compositions such as described above have excellent aging properties at low temperatures or in the short-term, these PPE resin compositions suffer from significant lowering of mechanical properties and flame retardance when they are aged for a long time in a high-temperature environment.

Accordingly, an objective of the present disclosure is to provide a flame-retardant resin composition having both excellent flame retardance and excellent long-term flame retardance (flame retardance after long-term heat aging for 1,000 hours at 150° C.).

The inventors conducted an investigation in order to solve the problems described above and, as a result, discovered that with respect to a resin composition containing (A) a polyphenylene ether, (B) a prescribed amount of a thermoplastic resin, such as a polystyrene resin, and a combination of at least two prescribed flame retardants, a decrease in flame retardance of the resin composition that occurs in a high-temperature environment can be suppressed as a result of a rate of change of insoluble content of the resin component being no greater than a prescribed value when the thermoplastic resin composition is molded to form a molded article of a prescribed size and is subjected to heat aging. This discovery led to the present disclosure.

Specifically, the present disclosure provides the following.

[1]

A flame-retardant resin composition comprising:

(A) a polyphenylene ether;

(B) at least one thermoplastic resin selected from the group consisting of (B-1) a polystyrene resin, (B-2) a polyamide resin, (B-3) a polypropylene resin, and (B-4) a polyphenylene sulfide resin; and

(C) a flame retardant, wherein

the (A) component has a content of less than 50 mass % when the flame-retardant resin composition minus ash content, corresponding to a residue obtained upon burning of the flame-retardant resin composition, is taken to be 100 mass %,

the flame-retardant resin composition has a flame retardance level of V-0 as measured by a UL 94 vertical burning test using a specimen of 2.0 mm in thickness, and

a molded article of 12.6 cm in length, 1.3 cm in width, and 1.6 mm in thickness formed from the flame-retardant resin composition exhibits a rate of change of chloroform-insoluble content of no greater than 15 mass % before and after being subjected to aging in which the molded article is left for 1,000 hours at 150° C. in an atmospheric environment.

[2]

The flame-retardant resin composition described in [1], wherein

the (C) component includes (C-1) a cyclic phosphazene compound represented by chemical formula (1), shown below, and (C-2) a phosphinic acid salt represented by chemical formula (3), shown below, or chemical formula (4), shown below,

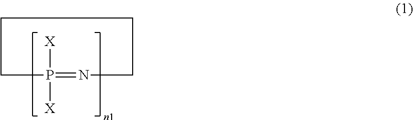

in chemical formula (1): n1 is an integer of 3-25; and X is a substituent selected from the group consisting of an alkyl group having a carbon number of 1-6, an aryl group having a carbon number of 6-11, a fluorine atom, an aryloxy group represented by general formula (2), shown below, a naphthyloxy group, an alkoxy group having a carbon number of 1-6, and an alkoxy-substituted alkoxy group, where each X may be the same or different to one another, and a portion of or all hydrogen atoms on the substituent represented by X may be substituted with a group selected from the group consisting of a fluorine atom, a hydroxy group, and a cyano group,

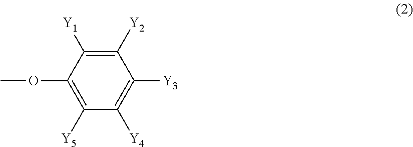

in general formula (2), Y₁, Y₂, Y₃, Y₄, and Y₅ are each, independently of one another, a sub stituent selected from the group consisting of a hydrogen atom, a fluorine atom, an alkyl group having a carbon number of 1-5, an alkoxy group having a carbon number of 1-5, a phenyl group, and a heteroatom-containing group,

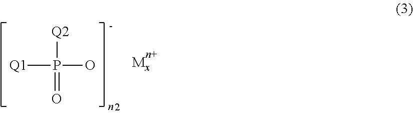

in chemical formula (3): Q1 and Q2 are each, independently of one another, a substituent selected from the group consisting of a hydrogen atom, an alkyl group having a carbon number of 1-12, an alkoxy group having a carbon number of 1-12, an aryl group, and an aryloxy group; n2 is an integer of 1-3; M is a metal element from period 4 or lower in the periodic table or a protonated nitrogen base, where each M may be the same or different in a situation in which x is 2; and n2=n×x, and

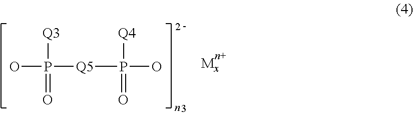

in chemical formula (4): Q3 and Q4 are each, independently of one another, a substituent selected from the group consisting of a hydrogen atom, an alkyl group having a carbon number of 1-12, an alkoxy group having a carbon number of 1-12, an aryl group, and an aryloxy group; Q5 is a group selected from the group consisting of an alkylene having a carbon number of 1-18, an arylalkylene, an arylene, an alkylarylene, and a diarylene; n3 is an integer of 1-3; x is an integer of 1 or 2; M is a group selected from the group consisting of a metal element from period 4 or lower in the periodic table and a protonated nitrogen base, where each M may be the same or different in a situation in which x is 2; and 2×x n3=n×x.

[3]

The flame-retardant resin composition described in [1], wherein

the (C-1) component and the (C-2) component have a total content of from 1 part by mass to 30 parts by mass when a total of the (A) component and the (B) component is taken to be 100 parts by mass.

[4]

The flame-retardant resin composition described in [1], further comprising

(D) an antioxidant, wherein

the (D) component is present independently in the flame-retardant resin composition without reacting with a polyphenylene ether, and the (D) component has a content of from 0.1 parts by mass to 20.0 parts by mass when the (A) component is taken to be 100 parts by mass.

[5]

The flame-retardant resin composition described in [4], wherein

the (D) component includes a phosphorus-containing antioxidant.

[6]

The flame-retardant resin composition described in [1], wherein the (A) component includes at least one structural unit selected from the group consisting of chemical formulae (5), (6), (7), (9), (10), (11), and (12), shown below,

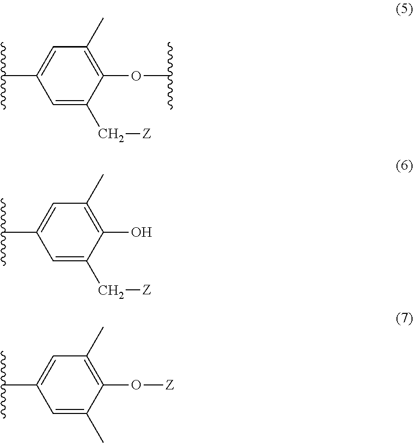

Z in chemical formulae (5), (6), and (7) is a group selected from groups shown in chemical formula (8),

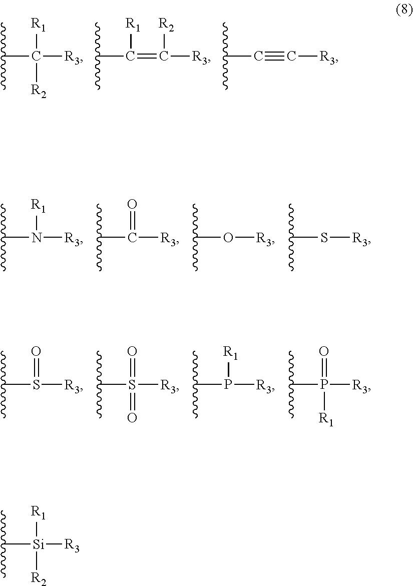

where, in chemical formula (8), R₁ to R₃ are each, independently of one another, a group selected from the group consisting of a hydrogen atom, an alkyl group, an aryl group, a hydroxy group, an alkoxy group, a carbonyl group, an amino group, and an amide group, and R₁ to R₃ may form a cyclic structure through bonding between atoms included therein,

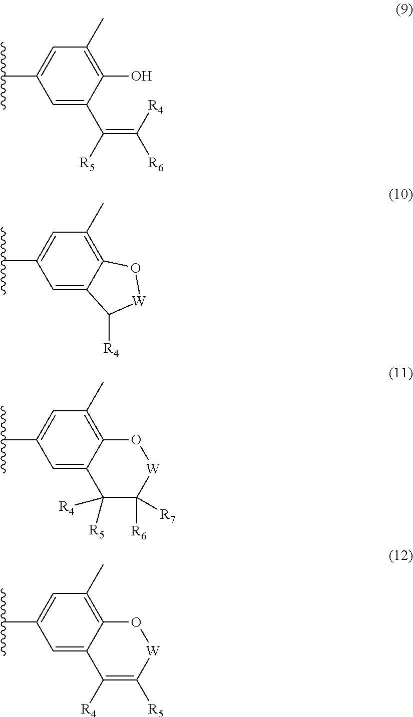

R₄ to R₇ in chemical formulae (9), (10), (11), and (12) are each, independently of one another, a group selected from the group consisting of a hydrogen atom, an alkyl group, an aryl group, a hydroxy group, an alkoxy group, a carbonyl group, an amino group, and an amide group,

W in chemical formulae (10), (11), and (12) is a group selected from structures shown in chemical formula (13),

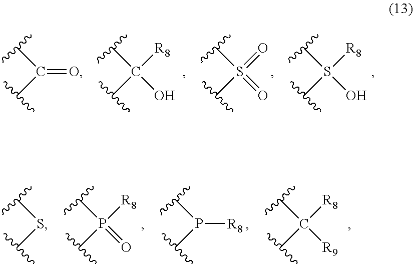

where, in chemical formula (13), R₈ and R₉ are each, independently of one another, a group selected from the group consisting of a hydrogen atom, an alkyl group, an aryl group, a hydroxy group, an alkoxy group, a carbonyl group, an amino group, and an amide group, and

R₆ or R₇ in chemical formulae (10), (11), and (12) and R₈ or R₉ in chemical formula (13) may form a cyclic structure through bonding between atoms included therein.

[7]

The flame-retardant resin composition described in [6], wherein

a structural unit shown in any one of chemical formulae (5), (6), (7), (9), (10), (11), and (12) is contained in an amount of from 0.1 units to 10 units per 100 monomer units forming the (A) component.

[8]

The flame-retardant resin composition described in [2], wherein

the (C-1) component and the (C-2) component have a total content of from 1 part by mass to 30 parts by mass when a total of the (A) component and the (B) component is taken to be 100 parts by mass.

[9]

The flame-retardant resin composition described in [2], further comprising

(D) an antioxidant, wherein

the (D) component is present independently in the flame-retardant resin composition without reacting with a polyphenylene ether, and the (D) component has a content of from 0.1 parts by mass to 20.0 parts by mass when the (A) component is taken to be 100 parts by mass.

[10]

The flame-retardant resin composition described in [3], further comprising

(D) an antioxidant, wherein

the (D) component is present independently in the flame-retardant resin composition without reacting with a polyphenylene ether, and

the (D) component has a content of from 0.1 parts by mass to 20.0 parts by mass when the (A) component is taken to be 100 parts by mass.

According to the present disclosure, it is possible to suppress a decrease in flame retardance after long-term aging that occurs when a resin composition is used to form a molded article.

Moreover, through the presently disclosed flame-retardant resin composition, it is possible to provide a molded article that is applicable for electric and electronic components, vehicle components, and so forth that are required to have a high level of resistance to heat aging.

### DETAILED DESCRIPTION

The following describes an embodiment of this disclosure (hereinafter, also referred to as “the present embodiment”) in detail. However, the present disclosure is not limited to the following embodiment and may be implemented with various alterations that are within the essential scope of the present disclosure.

Various components that can be used in a flame-retardant PPE resin composition of the present embodiment are described below in detail.

(A) Polyphenylene Ether

In the present embodiment, (A) a polyphenylene ether is used that is a homopolymer or a copolymer including a repeating unit (structural unit) represented by general formula (14), shown below, and/or a repeating unit represented by general formula (15), shown below.

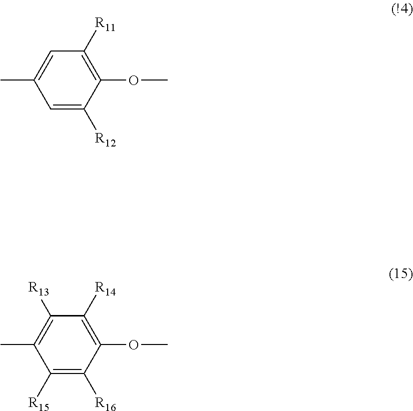

(In formulae (14) and (15), R₁₁, R₁₂, R₁₃, R₁₄, R₁₅, and R₁₆ each represent, independently of one another, a hydrogen atom, an alkyl group having a carbon number of 1-4, an aryl group having a carbon number of 6-9, or a halogen atom, but R₁₄ and R₁₆ are not both simultaneously hydrogen atoms.)

Representative examples of polyphenylene ether homopolymers that can be used include poly(2,6-dimethyl-1,4-phenylene) ether, poly(2-methyl-6-ethyl-1,4-phenylene) ether, poly(2,6-diethyl-1,4-phenylene) ether, poly(2-ethyl-6-n-propyl-1,4-phenylene) ether, poly(2, 6-di-n-propyl-1,4-phenylene) ether, poly(2-methyl-6-n-butyl-1,4-phenylene) ether, poly(2-ethyl-6-isopropyl-1,4-phenylene) ether, poly(2-methyl-6-chloroethyl-1,4-phenylene) ether, poly(2-methyl-6-hydroxyethyl-1,4-phenylene) ether, and poly(2-methyl-6-chloroethyl-1,4-phenylene) ether.

The polyphenylene ether copolymer is a copolymer having a repeating unit represented by general formula (14) and/or a repeating unit represented by general formula (15) as a main repeating unit. Examples of polyphenylene ether copolymers that can be used include a copolymer of 2,6-dimethylphenol and 2,3,6-trimethylphenol, a copolymer of 2,6-dimethylphenol and o-cresol, and a copolymer of 2,6-dimethyphenol, 2,3,6-trimethylphenol, and o-cresol.

Among the polyphenylene ethers described above, poly(2,6-dimethyl-1,4-phenylene) ether is preferable, and a polyphenylene ether including a 2-(dialkylaminomethyl)-6-methylphenylene ether unit, a 2-(N-alkyl-N-phenylaminomethyl)-6-methylphenylene ether unit, or the like such as described in JP S63-301222 A as a partial structure thereof is particularly preferable.

In the polyphenylene ether, the concentration of terminal OH groups per 100 monomer units forming the polyphenylene ether is preferably from 0.4 groups to 2.0 groups, and more preferably from 0.6 groups to 1.3 groups.

The concentration of terminal OH groups in the PPE can be calculated by NMR measurement; for example, a method described in the EXAMPLES section may be used.

The reduced viscosity (units: dL/g, chloroform solvent, measured at 30° C.) of the polyphenylene ether is preferably in a range of from 0.25 to 0.6, and more preferably in a range of from 0.35 to 0.55. The number average molecular weight (Mn) of the polyphenylene ether is preferably no greater than 20,000, and more preferably no greater than 19,000. The molecular weight range described above provides an excellent balance of flame retardance, fluidity, close adherence to a filler, and so forth.

In general, (A) the polyphenylene ether can be acquired as a powder that, in terms of particle size, preferably has an average particle diameter of from 1 μm to 1,000 μm, more preferably from 10 μm to 700 μm, and particularly preferably from 100 μm to 500 μm. An average particle diameter of at least 1 μm is preferable from a viewpoint of ease of handling during processing and an average particle diameter of no greater than 1,000 μm is preferable in order to inhibit the occurrence of unmelted matter in melt-kneading.

In the present embodiment, (A) the polyphenylene ether is preferably a modified polyphenylene ether.

It is preferable that (A) the polyphenylene ether used in the present embodiment includes at least one structural unit selected from the group consisting of chemical formulae (5), (6), (7), (9), (10), (11), and (12), shown below, with a content per 100 units in (A) the polyphenylene ether in a range of from 0.1 units to 10 units, more preferably in a range of from 0.2 units to 5.0 units, and further preferably in a range of from 0.2 units to 3.0 units.

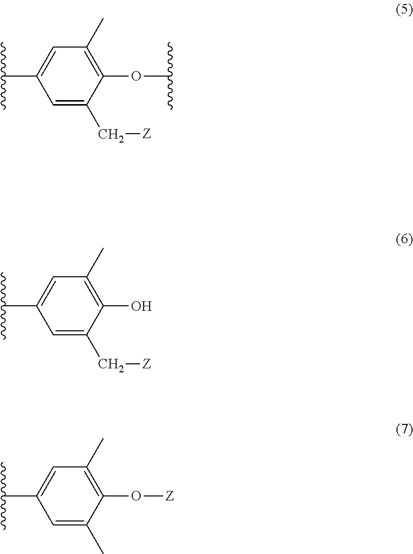

(Z in formulae (5), (6), and (7) is a group selected from groups shown in chemical formula (8), where R₁ to R₃ in formula (8) are each, independently of one another, a group selected from the group consisting of a hydrogen atom, an alkyl group, an aryl group, a hydroxy group, an alkoxy group, a carbonyl group, an amino group, and an amide group, and R₁ to R₃ may form a cyclic structure through bonding between atoms included therein.)

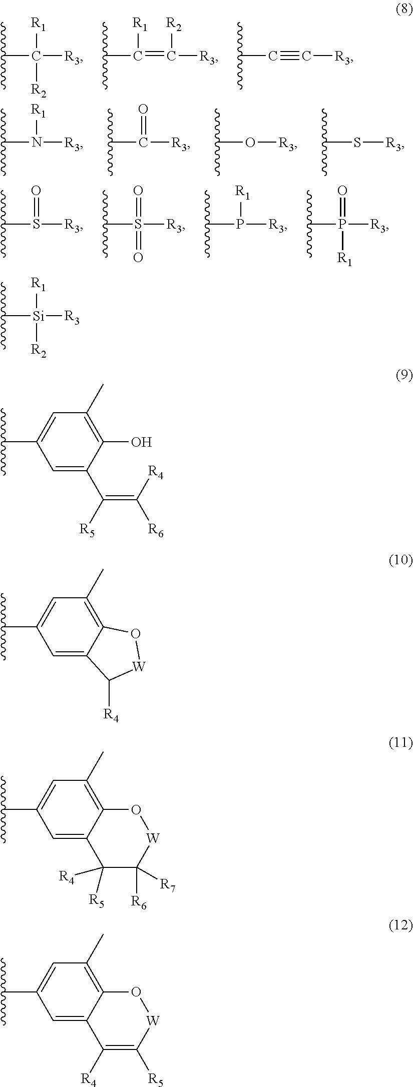

(R₄ to R₇ in formulae (9), (10), (11), and (12) are each, independently of one another, a group selected from the group consisting of a hydrogen atom, an alkyl group, an aryl group, a hydroxy group, an alkoxy group, a carbonyl group, an amino group, and an amide group. W in formulae (10), (11), and (12) is a group selected from structures shown in chemical formula (13), where R₈ and R₉ in formula (13) are each, independently of one another, a group selected from the group consisting of a hydrogen atom, an alkyl group, an aryl group, a hydroxy group, an alkoxy group, a carbonyl group, an amino group, and an amide group. R₆ or R₇ in formulae (10), (11), and (12) and R₈ or R₉ in formula (13) may form a cyclic structure through bonding between atoms included therein.)

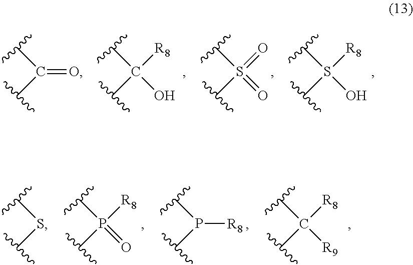

With respect to R₁ to R₃ in formula (8), the alkyl group may for example be a substituted or unsubstituted alkyl group that has a carbon number of 1-50, and preferably 1-30, and that is linear, branched, or cyclic, and preferably linear or cyclic.

The aryl group may for example be an aromatic hydrocarbon group or heteroaromatic group that has a carbon number of 6-20, and preferably 6-14. Specific examples include aromatic hydrocarbon groups such as a phenyl group, a naphthyl group, a pyrenyl group, a phenanthrenyl group, and an anthracenyl group; and heteroaromatic groups such as an imidazole group, a pyrazole group, an oxazole group, a thiazole group, a pyrazine group, a pyridyl group, a quinoline group, and an isoquinoline group, with a phenyl group and a pyridyl group being preferable.

The alkoxy group, the ester group, and the amide group may for example each be a group including a substituted or unsubstituted hydrocarbon group that has a carbon number of 1-50, and preferably 1-30, and that is linear, branched, or cyclic, and preferably linear or cyclic.

A plurality of groups (for example, two or three groups) among R₁ to R₃ in formula (8) may form a cyclic structure through bonding between atoms included therein.

In one suitable example of (A) the polyphenylene ether that is used in the present embodiment, Z in formula (5) and/or formula (6) is —P(═O)(R₁)(OR₂), where R₁ is a phenyl group, R₂ is a phenyl group, and R₁ and R₂ form a biphenyl structure through a single bond at respective ortho positions thereof.

In another suitable example of (A) the polyphenylene ether that is used in the present embodiment, Z in formula (5) and/or formula (6) is —P(═O)(OR₁)(OR₂), where R₁ is an octyl group and R₂ is an octyl group.

In another suitable example of (A) the polyphenylene ether that is used in the present embodiment, Z in formula (5) and/or formula (6) is —S(═O)(═O)(R₁), where R₁ is a methyl group.

In another suitable example of (A) the polyphenylene ether that is used in the present embodiment, Z in formula (7) is —C(═O)(R₁), where R₁ is a pyridyl group.

In another suitable example of (A) the polyphenylene ether that is used in the present embodiment, Z in formula (7) is —S(═O)(═O)(R₁), where R₁ is a phenyl group.

With respect to R₄ to R₇ in formulae (9), (10), (11), (12), and (13), the alkyl group may for example be a substituted or unsubstituted alkyl group that has a carbon number of 1-50, and preferably 1-30, and that is linear, branched, or cyclic, and preferably chain-shaped or cyclic.

The aryl group may for example be an aromatic hydrocarbon group or a heteroaromatic group that has a carbon number of 6-20, and preferably 6-14. Specific examples include aromatic hydrocarbon groups such as a phenyl group, a naphthyl group, a pyrenyl group, a phenanthrenyl group, and an anthracenyl group; and heteroaromatic groups such as an imidazole group, a pyrazole group, an oxazole group, a thiazole group, a pyrazine group, a pyridyl group, a quinoline group, and an isoquinoline group, with a phenyl group and a pyridyl group being preferable.

The alkoxy group, the ester group, and the amide group may for example each include a substituted or unsubstituted hydrocarbon group that has a carbon number of 1-50, and preferably 1-30, and that is linear, branched, or cyclic, and preferably chain-shaped or cyclic.

A plurality of groups (for example, two, three, or four groups) among R₆ and R₇ in formulae (10), (11), and (12) and R₈ and R₉ in formula (13) may form a cyclic structure though bonding between atoms included therein.

In another suitable example of (A) the polyphenylene ether that is used in the present embodiment, W in formula (11) is —C(R₁₀)(R₁₁)—, where R₄, R₅, R₆, R₁₀, and R₁₁ are hydrogen atoms and R₇ is an ester group —C(═O)(C₁₈H₃₇).

In another suitable example of (A) the polyphenylene ether that is used in the present embodiment, W in formula (11) is —C(R₁₀)(R₁₁)—, where R₄, R₅, R₆, R₇, and R₁₀ are hydrogen atoms and R₁₁ is a phenyl group.

In another suitable example of (A) the polyphenylene ether that is used in the present embodiment, W in formula (11) is —C(R₁₀)(R₁₁)—, where R₄, R₅, R₆, and R₁₁ are hydrogen atoms, R₇ is a carboxyl group, R₁₀ is a carboxyl group, and R₇ and R₁₀ form an acid anhydride.

<Synthesis Method of Modified Polyphenylene Ether>

The modified polyphenylene ether (hereinafter, also referred to simply as “modified PPE”) is preferably obtained by reacting a reactive compound with a precursor polyphenylene ether (hereinafter, also referred to as “precursor PPE”) having the structures in chemical formulae (16) and (17).

The precursor polyphenylene ether is preferably a polyphenylene ether that includes structural units having the terminal group and side chain group represented by formulae (16) and (17), shown below, in a polyphenylene ether chain. As a result of the precursor PPE including the structural units in formulae (16) and (17), it is possible to obtain the modified polyphenylene ether with sufficient efficiency (specifically, in production of the modified PPE, the modified PPE can be produced via the precursor PPE with sufficient efficiency because the CH₂—Y part of the structures in formulae (16) and (17) is selectively cleaved and undergoes a substitution reaction with the reactive compound described further below). Moreover, since the precursor PPE can be easily synthesized from an unsubstituted PPE, (A) the PPE can be efficiently synthesized via the precursor PPE.

Furthermore, the total amount of the aforementioned structural units in the polyphenylene ether chain of the precursor PPE is preferably from 0.1 units to 10 units per 100 units of the polyphenylene ether chain.

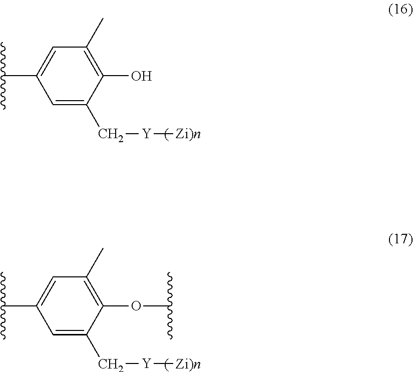

(In formulae (16) and (17), Y represents an N atom or an O atom, and Z₁ represents a saturated or unsaturated hydrocarbon group that has a carbon number of 1-20 and that is cyclic or chain-shaped (i.e., linear or branched). Furthermore, in formulae (16) and (17), i and n are each an integer of 1 or 2, where Z₁ and Z₂ may be the same or different and may form a cyclic structure in conjunction with Y bonded thereto through bonding therebetween.)

No specific limitations are placed on the method used to produce the precursor polyphenylene ether having the structural units in formulae (16) and (17). Examples of methods that can be used include a method in which (al) a compound such as an amine, an alcohol, or morpholine is added and caused to react in a polymerization reaction of a polyphenylene ether and a method in which an unsubstituted polyphenylene ether that has been polymerized is stirred at from 20° C. to 60° C., and preferably at 40° C., in a solvent such as toluene in which the PPE is soluble, and the aforementioned (al) compound is added thereto and is caused to react.

Although no specific limitations are placed on the (a1) compound, specific examples thereof include primary amines such as n-propylamine, isopropylamine, n-butylamine, isobutylamine, sec-butylamine, n-hexylamine, n-octylamine, 2-ethylhexylamine, cyclohexylamine, laurylamine, and benzylamine; secondary amines such as diethylamine, di-n-propylamine, di-n-butylamine, diisobutylamine, di-n-octylamine, piperidine, and 2-pipecoline; alcohols such as methanol, ethanol, n-propanol, isopropanol, n-butanol, isobutanol, and sec-butanol; and morpholine.

No specific limitations are placed on the method used to obtain the modified polyphenylene ether. Examples of methods that can be used include a method in which a reactive compound described further below is added in polymerization of a polyphenylene ether and polymerization is carried out, a method in which a small amount of a monomer substituted with a reactive compound described further below is added in polymerization of a polyphenylene ether and polymerization is carried out, and a method in which a precursor polyphenylene ether and a reactive compound are melt-kneaded and caused to react. More specific examples include a method in which the (a1) compound is added and caused to react in polymerization of PPE, and a reactive compound described further below is subsequently caused to react, a method in which a small amount of 2,6-dimethylphenol that has been substituted with the (a1) compound is added and caused to react in polymerization of PPE, and a method in which a precursor PPE is obtained and the precursor PPE and a reactive compound are subsequently melt-kneaded and caused to react (i.e., the precursor PPE and the reactive compound are for example melt-kneaded in production of a resin composition by melt kneading using the precursor PPE).

Although there are no specific limitations on reactive compounds that can be used in order to obtain the modified polyphenylene ether in the present embodiment, examples thereof include vinyl compounds, acid anhydrides, monocarboxylic acids and derivatives thereof, alcohols, glycidyl compounds (epoxy compounds), phosphorus-containing compounds such as phosphonic acids, phosphonic acid esters, phosphinic acids, and phosphinic acid esters, thiols, sulfonic acids, sulfinic acids, and amino compounds.

Examples of vinyl compounds that can be used include those described in PTL 4 (JP 2925646 B2) and JP 2001-302791 A. Specific examples include styrene, α-methylstyrene, chlorostyrene, methylstyrene, stilbene, cinnamic alcohol, benzalacetone, ethyl cinnamate, cinnamonitrile, 4-vinylpyridine, 2-vinyl-3,5-diamino-(s)-triazine, acrylic acid, acrylic acid esters (the ester part may for example be a methyl, ethyl, propyl, butyl, isobutyl, tert-butyl, 2-ethylhexyl, octyl, isodecyl, lauryl, lauryl-tridecyl, tridecyl, cetyl-stearyl, stearyl, cyclohexyl, or benzyl ester), acrylamide, acrylonitrile, methacrylic acid, methacrylic acid esters (the ester part may for example be a methyl, ethyl, propyl, butyl, isobutyl, tert-butyl, 2-ethylhexyl, octyl, isodecyl, lauryl, lauryl-tridecyl, tridecyl, cetyl-stearyl, stearyl, cyclohexyl, or benzyl ester), methacrylamide, methacrylonitrile, itaconic acid, itaconic acid diesters (the ester part may for example be a dimethyl, diethyl, dibutyl, di-2-ethylhexyl, dinonyl, or dioctyl ester), itaconic acid monoesters (the ester part may for example be a monomethyl, monoethyl, monobutyl, mono-2-ethylhexyl, mononoryl, or monooctyl ester), itaconic anhydride, N-vinyl compounds (for example, N-vinylpyrrolidone), and vinyl ethers (for example, butyl vinyl ether).

Examples of acid anhydrides that can be used include acetic anhydride, succinic anhydride, maleic anhydride, salicylic anhydride, phthalic anhydride, acrylic anhydride, and methacrylic anhydride.

Examples of monocarboxylic acids and derivatives thereof that can be used include monocarboxylic acids (for example, formic acid, acetic acid, propionic acid, butyric acid, hexanoic acid, heptanoic acid, octanoic acid, nonanoic acid, decanoic acid, dodecanoic acid, tetradecanoic acid, octadecanoic acid, docosanoic acid, hexacosanoic acid, octadecenoic acid, docosenoic acid, and isooctadecanoic acid), alicyclic monocarboxylic acids (for example, cyclohexane carboxylic acid), aromatic monocarboxylic acids (for example, benzoic acid, methylbenzoic acid, and isonicotinic acid), hydroxy aliphatic monocarboxylic acids (for example, hydroxypropionic acid, hydroxyoctadecanoic acid, and hydroxyoctadecenoic acid), sulfur-containing aliphatic monocarboxylic acids (for example, alkyl thiopropionic acid), and esters, halogenated products, and salts of the preceding monocarboxylic acids.

Examples of alcohols that can be used include methanol, ethanol, n-propanol, isopropanol, n-butanol, isobutanol, sec-butanol, phenol, ethanediol, propanediol, and benzenetriol.

Examples of glycidyl compounds (epoxy compounds) that can be used include compounds represented by general formula (18).

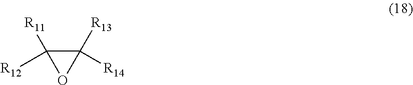

(In formula (18), R₁₁ to R₁₄ are each, independently of one another, a group selected from the group consisting of a hydrogen atom, an alkyl group including at least one carbon atom, a hydroxy group, an alkoxy group, and a carbonyl group.)

Examples of phosphonic acids that can be used include phosphonic acid, methylphosphonic acid, ethylphosphonic acid, vinylphosphonic acid, decylphosphonic acid, phenylphosphonic acid, benzylphosphonic acid, aminomethylphosphonic acid, methylenediphosphonic acid, 1-hydroxyethane-1,1-diphosphonic acid, 4-methoxyphenylphosphonic acid, propylphosphonic anhydride, and derivatives of the preceding phosphonic acids.

Examples of phosphonic acid esters that can be used include dimethyl phosphonate, diethyl phosphonate, bis(2-ethylhexyl) phosphonate, dioctyl phosphonate, dilauryl phosphonate, dioleyl phosphonate, diphenyl phosphonate, dibenzyl phosphonate, dimethyl methylphosphonate, diphenyl methylphosphonate, dioctyl methylphosphonate, diethyl ethylphosphonate, dioctyl ethylphosphonate, diethyl benzylphosphonate, dimethyl phenylphosphonate, diethyl phenylphosphonate, dipropyl phenylphosphonate, dioctyl phenylphosphonate, diethyl (methoxymethyl)phosphonate, dioctyl (methoxymethyl)phosphonate, diethyl vinylphosphonate, diethyl hydroxymethylphosphonate, dimethyl (2-hydroxyethyl)phosphonate, dioctyl (methoxymethyl)phosphonate, diethyl p-methylbenzylphosphonate, dioctyl p-methylbenzylphosphonate, di ethylphosphonoacetate, ethyl diethylphosphonoacetate, tert-butyl diethylphosphonoacetate, dioctyl diethylphosphonate, diethyl (4-chlorobenzyl)phosphonate, dioctyl (4-chlorobenzyl)phosphonate, diethyl cyanophosphonate, diethyl cyanomethylphosphonate, dioctyl cyanophosphonate, diethyl 3,5-di -tert-butyl-4-hydroxybenzylphosphonate, dioctyl 3,5-di -tert-butyl-4-hydroxybenzylphosphonate, and diethyl (methylthiomethyl)phosphonate.

Examples of phosphinic acids that can be used include dimethylphosphinic acid, ethylmethylphosphinic acid, diethylphosphinic acid, methyl-n-propylphosphinic acid, diphenylphosphinic acid, dioleylphosphinic acid, 9,10-dihydro-9-oxa-10-phosphaphenanthrene-10-oxide, and derivatives of the preceding phosphinic acids.

Examples of phosphinic acid esters that can be used include methyl dimethylphosphinate, ethyl dimethylphosphinate, n-butyl dimethylphosphinate, cyclohexyl dimethylphosphinate, vinyl dimethylphosphinate, phenyl dimethylphosphinate, methyl ethylmethylphosphinate, ethyl ethylmethylphosphinate, n-butyl ethylmethylphosphinate, cyclohexyl ethylmethylphosphinate, vinyl ethylmethylphosphinate, phenyl ethylmethylphosphinate, methyl diethylphosphinate, ethyl diethylphosphinate, n-butyl diethylphosphinate, cyclohexyl diethylphosphinate, vinyl diethylphosphinate, phenyl diethylphosphinate, methyl diphenylphosphinate, ethyl diphenylphosphinate, n-butyl diphenylphosphinate, cyclohexyl diphenylphosphinate, vinyl diphenylphosphinate, phenyl diphenylphosphinate, methyl methyl-n-propylphosphinate, ethyl methyl-n-propylphosphinate, n-butyl methyl-n-propylphosphinate, cyclohexyl methyl-n-propylphosphinate, vinyl methyl-n-propylphosphinate, phenyl methyl-n-propylphosphinate, methyl dioleylphosphinate, ethyl dioleylphosphinate, n-butyl dioleylphosphinate, cyclohexyl dioleylphosphinate, vinyl dioleylphosphinate, and phenyl dioleylphosphinate.

Examples of thiols that can be used include methanethiol, ethanethiol, n-propanethiol, i-propanethiol, phenylthiol, and benzothiol.

Examples of sulfonic acids that can be used include alkyl sulfonic acids, benzenesulfonic acid, naphthalenesulfonic acid, anthraquinonesulfonic acid, camphorsulfonic acid, and derivatives of the preceding sulfonic acids. These sulfonic acids may be monosulfonic acids, disulfonic acids, or trisulfonic acids. Examples of derivatives of benzenesulfonic acid that can be used include phenolsulfonic acid, styrenesulfonic acid, toluenesulfonic acid, dodecylbenzenesulfonic acid, and esters, halogenated products, and salts of the preceding benzenesulfonic acid derivatives. Examples of derivatives of naphthalenesulfonic acid that can be used include 1-naphthalenesulfonic acid, 2-naphthalenesulfonic acid, 1,3-naphthalenedi sulfonic acid, 1,3,6-naphthalenetrisulfonic acid, and 6-ethyl-1-naphthalenesulfonic acid. Examples of derivatives of anthraquinonesulfonic acid that can be used include anthraquinone-1-sulfonic acid, anthraquinone-2-sulfonic acid, anthraquinone-2,6-disulfonic acid, and 2-methylanthraquinone-6-sulfonic acid.

Examples of sulfinic acids that can be used include alkane sulfinic acids such as ethanesulfinic acid, propanesulfinic acid, hexanesulfinic acid, octanesulfinic acid, decanesulfinic acid, and dodecanesulfinic acid; alicyclic sulfinic acids such as cyclohexanesulfinic acid and cycloctanesulfinic acid; and aromatic sulfinic acids such as benzenesulfinic acid, o-toluenesulfinic acid, p-toluenesulfinic acid, ethylbenzenesulfinic acid, decylbenzenesulfinic acid, dodecylbenzenesulfinic acid, chlorobenzenesulfinic acid, and naphthalenesulfinic acid.

Examples of amino compounds that can be used include ethylamine, diethylamine, n-butylamine, di-n-butylamine, tert-butylamine, di-tert-butylamine, phenylamine, and diphenylamine.

From a viewpoint of reactivity, the reactive compound is preferably a phosphorus-containing compound. Specifically, the reactive compound is preferably diphenyl phosphonate, dioleyl phosphonate, diphenylphosphinic acid, or dioleylphosphinic acid, and is more preferably 9,10-dihydro-9-oxa-10-phosphaphenanthrene-10-oxide.

Through use of (A) a polyphenylene ether that is obtained using 9,10-dihydro-9-oxa-10-phosphaphenanthrene-10-oxide, it is possible to improve resistance to heat aging and also further improve fluidity during melt-kneading of the resin composition in which the PPE is used.

(B) Thermoplastic Resin

The following describes (B) a thermoplastic resin used in the present embodiment.

(B-1) Polystyrene Resin

In the present embodiment, (B-1) a polystyrene resin may be used that is a homopolymer of styrene or a styrene derivative, or a copolymer having styrene or a styrene derivative as a main component. Although no specific limitations are placed on the styrene derivative, examples thereof include o-methyl styrene, m-methyl styrene, p-methyl styrene, tert-butyl styrene, α-methylstyrene, β-methylstyrene, diphenylethylene, chlorostyrene, and bromostyrene.

Examples of homopolymer polystyrene resins that can be used include polystyrene, poly(α-methylstyrene), and poly(chlorostyrene).

Examples of copolymer polystyrene resins that can be used include, but are not specifically limited to, a styrene-butadiene copolymer, a styrene-acrylonitrile copolymer, a styrene-maleic acid copolymer, a styrene-maleic anhydride copolymer, a styrene-maleimide copolymer, a styrene-N-phenylmaleimide copolymer, a styrene-N-alkylmaleimide copolymer, a styrene-N-alkyl-substituted phenylmaleimide copolymer, a styrene-acrylic acid copolymer, a styrene-methacrylic acid copolymer, a styrene-methylacrylate copolymer, a styrene-methyl methacrylate copolymer, a styrene-n-alkyl acrylate copolymer, a styrene-n-alkyl methacrylate copolymer, an ethylvinylbenzene-divinylbenzene copolymer, terpolymers such as ABS and a butadiene-acrylonitrile-α-methylbenzene copolymer, and graft copolymers such as styrene-grafted polyethylene, a styrene-grafted ethylene-vinyl acetate copolymer, (styrene-acrylic acid)-grafted polyethylene, and styrene-grafted polyamide.

Any one of these polystyrene resins may be used individually, or any two or more of these polystyrene resins may be used in combination.

The content of (B-1) the polystyrene resin in the resin composition relative to 100 parts by mass of (A) the polyphenylene ether is preferably from 100 parts by mass to 1,900 parts by mass, and more preferably from 100 parts by mass to 900 parts by mass.

(B-2) Polyamide Resin

In the present embodiment, (B-2) a polyamide resin may be used that is any polymer having an amide bond [—NH—C(═O)—] in a repeating unit (structural unit) thereof.

Polyamides are generally obtained through ring opening polymerization of a lactam, polycondensation of a diamine and a dicarboxylic acid, or polycondensation of an aminocarboxylic acid. However, (B-2) the polyamide resin is not limited to being obtained by these methods.

Diamines that can be used are broadly classified as aliphatic diamines, alicyclic diamines, and aromatic diamines. Specific examples include tetramethylenediamine, hexamethylenediamine, nonamethylenediamine, undecamethylenediamine, dodecamethylenediamine, tridecamethylenediamine, 2-methyl-1,8-octamethylenediamine, 2,2,4-trimethylhexamethylenediamine, 2,4,4-trimethylhexamethylenediamine, 5-methylnonamethylenediamine, 1,3-bisaminomethylcyclohexane, 1,4-bisaminomethylcyclohexane, m-phenylenediamine, p-phenylenediamine, m-xylylenediamine, and p-xylylenediamine.

Dicarboxylic acids that can be used are broadly classified as aliphatic dicarboxylic acids, alicyclic dicarboxylic acids, and aromatic dicarboxylic acids. Specific examples include adipic acid, suberic acid, azelaic acid, sebacic acid, dodecanedioic acid, 1,1,3-tridecanedioic acid, 1,3-cyclohexanedicarboxylic acid, terephthalic acid, isophthalic acid, naphthalenedicarboxylic acid, and dimer acids.

Specific examples of lactams that can be used include c-caprolactam, enantholactam, and ω-laurolactam.

Specific examples of aminocarboxylic acids that can be used include, ε-aminocaproic acid, 7-aminoheptanoic acid, 8-aminooctanoic acid, 9-aminononanoic acid, 11-aminoundecanoic acid, 12-aminododecanoic acid, and 13-aminotridecanoic acid.

In the present disclosure, any copolymerized polyamide obtained by polycondensation of one or a mixture of two or more of the diamines, dicarboxylic acids, lactams, and aminocarboxylic acids listed above may be used.

Moreover, it is also possible to suitably use a product that is obtained by polymerizing any of these lactams, diamines, dicarboxylic acids, and w-aminocarboxylic acids in a polymerization reactor until a low molecular weight oligomer stage is reached and then carrying out polymerization to reach a high molecular weight in an extruder or the like.

In particular, examples of polyamides that can be effectively used in the present disclosure include polyamide 6, polyamide 6,6, polyamide 4,6, polyamide 11, polyamide 12, polyamide 6,10, polyamide 6,12, polyamide 6/6,6 polyamide 6/6,12, polyamide 6,MXD (m-xylylenediamine), polyamide 6,T, polyamide 6,I, polyamide 6/6,T, polyamide 6/6,I, polyamide 6,6/6,T, polyamide 6,6/6,I, polyamide 6/6,T/6,I, polyamide 6,6/6,T/6,I, polyamide 6/12/6,T, polyamide 6,6/12/6,T, polyamide 6/12/6,I, polyamide 6,6/12/6,I, and polyamide 9,T. Furthermore, polyamides obtained by copolymerizing a plurality of polyamides in an extruder or the like can also be used.

The polyamide is preferably polyamide 6, polyamide 6,6, polyamide 6/6,6, or a mixture thereof, and is most preferably polyamide 6,6 used individually or a mixture of polyamide 6,6 and polyamide 6.

In a situation in which a mixture of polyamide 6,6 and polyamide 6 is used as the polyamide, the amount of polyamide 6,6 is preferably from 70 mass % to 99 mass %, and more preferably from 85 mass % to 95 mass % when the amount of the mixture of all polyamide 6,6 and polyamide 6 that is used is taken to be 100 mass %.

A viscosity number of the polyamide used in the present disclosure that is measured in accordance with ISO 307:1994 using 96% sulfuric acid is preferably from 100 mL/g to 130 mL/g, and more preferably from 110 mL/g to 128 mL/g. The use of a polyamide having a viscosity number in the range described above enables a better balance of fluidity and mechanical properties of the resin composition.

The polyamide used in the present disclosure may be a mixture of a plurality of types of polyamides having different viscosity numbers. In a situation in which a plurality of types of polyamides are used, the polyamide mixture thereof preferably has a viscosity number in the range described above. It can easily be confirmed that the polyamide mixture has a viscosity number in the range described above through actual measurement of the mixture of polyamides that have been mixed in a desired mixing ratio.

The content of (B-2) the polyamide resin in the resin composition relative to 100 parts by mass of (A) the polyphenylene ether is preferably from 100 parts by mass to 1,900 parts by mass, and more preferably from 100 parts by mass to 900 parts by mass.

(B-3) Polypropylene Resin

In the present embodiment, (B-3) a polypropylene resin may be used that is, for example, a crystalline propylene homopolymer, a crystalline propylene-ethylene block copolymer including a crystalline propylene homopolymer portion obtained in a first stage of polymerization and a propylene-ethylene random copolymer portion obtained through copolymerization of propylene, ethylene, and/or one or more other α-olefins (for example, 1-butene or 1-hexane) in a second stage or later of polymerization, or a mixture of the aforementioned crystalline propylene homopolymer and the aforementioned crystalline propylene-ethylene block copolymer.

The content of (B-3) the polypropylene resin in the resin composition relative to 100 parts by mass of (A) the polyphenylene ether is preferably from 100 parts by mass to 1,900 parts by mass, and more preferably from 100 parts by mass to 900 parts by mass.

(B-4) Polyphenylene Sulfide Resin

In the present embodiment, (B-4) a polyphenylene sulfide resin may be used that is a polymer typically including at least 50 mol % of an arylene sulfide repeating unit in general formula (A), shown below, preferably including at least 70 mol % of the arylene sulfide repeating unit, and more preferably including at least 90 mol % of the arylene sulfide repeating unit.

[—Ar—S—] (A)

(In formula (A), Ar is an arylene group.)

Examples of the arylene group include a p-phenylene group, an m-phenylene group, a substituted phenylene group (the substituent is preferably an alkyl group having a carbon number of 1-10 or a phenyl group), a p,p′-diphenylene sulfone group, a p,p′-biphenylene group, a p,p′-diphenylene carbonyl group, and a naphthylene group.

The polyphenylene sulfide resin (PPS) may be a homopolymer including one type of arylene group as a constitutional unit, or may be a copolymer obtained using a mixture of two different types of arylene groups in order to improve processability and heat resistance. Among such resins, PPS having a p-phenylene sulfide repeating unit as a main constituent thereof is preferable in terms of having excellent processability and heat resistance, and being easy to industrially acquire.

The content of (B-4) the polyphenylene sulfide resin in the resin composition relative to 100 parts by mass of (A) the polyphenylene ether is preferably from 100 parts by mass to 1,900 parts by mass, and more preferably from 100 parts by mass to 900 parts by mass.

When the total of the (A) component and the (B) component in the flame-retardant resin composition of the present embodiment is taken to be 100 parts by mass, the content of the (B) component is from 50 parts by mass to 95 parts by mass, preferably from 50 parts by mass to 75 parts by mass, and more preferably from 50 parts by mass to 65 parts by mass.

The following describes (C-1) a cyclic phosphazene compound and (C-2) a phosphinic acid salt that are used together in the flame-retardant resin composition of the present embodiment.

(C-1) Cyclic Phosphazene Compound

A wide range of conventional commonly known cyclic phosphazene compounds can be used as (C-1) the cyclic phosphazene compound used in the present embodiment.

One example of a structure of a cyclic phosphazene compound that can be suitably used in the present embodiment is that of a cyclic phosphazene compound in general formula (1), shown below, which is described in “Inorganic Polymers; James E. Mark, Harry R. Allcock, Robert West; Pretice-Hall International, Inc.; 1992; p 61-p 140”. Moreover, the cyclic phosphazene compound used in the present embodiment preferably contains at least 95 mass % of a phosphazene compound having the aforementioned structure.

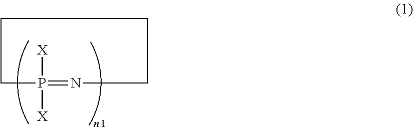

(In formula (1), n1 is an integer of 3-25; X is a substituent selected from the group consisting of an alkyl group having a carbon number of 1-6, an aryl group having a carbon number of 6-11, a fluorine atom, an aryloxy group in general formula (2), shown below, a naphthyloxy group, an alkoxy group having a carbon number of 1-6, and an alkoxy-substituted alkoxy group, where each X may be the same or different, and a portion of or all hydrogen atoms on the substituent represented by X may be substituted with a group selected from the group consisting of a fluorine atom, a hydroxy group, and a cyano group.)

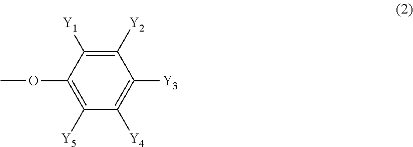

(In formula (2), Y₁, Y₂, Y₃, Y₄, and Y₅ are each, independently of one another, a substituent selected from the group consisting of a hydrogen atom, a fluorine atom, an alkyl group having a carbon number of 1-5, an alkoxy group having a carbon number of 1-5, a phenyl group, and a heteroatom-containing group.)

One of such compounds may be used individually, or two or more of such compounds may be used as a mixture.

Examples of the sub stituent X in the cyclic phosphazene compound include, but are not specifically limited to, alkyl groups such as a methyl group, an ethyl group, an n-propyl group, an isopropyl group, an n-butyl group, an s-butyl group, a tert-butyl group, an n-amyl group, and an isoamyl group; aryl groups such as a phenyl group, a 2-methylphenyl group, a 3-methylphenyl group, a 4-methylphenyl group, a 2,6-dimethylphenyl group, a 3,5-dimethylphenyl group, a 2,5-dimethylphenyl group, a 2,4-dimethylphenyl group, a 3,4-dimethylphenyl group, a 4-tert-butylphenyl group, and a 2-methyl-4-tert-butylphenyl group; alkoxy groups such as a methoxy group, an ethoxy group, an n-propoxy group, an isopropoxy group, an n-butoxy group, a tert-butoxy group, an s-butoxy group, an n-amyloxy group, an isoamyloxy group, a tert-amyloxy group, and an n-hexyloxy group; alkoxy-substituted alkoxy groups such as a methoxymethoxy group, a methoxyethoxy group, a methoxyethoxymethoxy group, a methoxyethoxyethoxy group, and a methoxypropoxy group; a phenoxy group; alkyl-substituted phenoxy groups such as a 2-methylphenoxy group, a 3-methylphenoxy group, a 4-methylphenoxy group, a 2,6-dimethylphenoxy group, a 2,5-dimethylphenoxy group, a 2,4-dimethylphenoxy group, a 3,5-dimethylphenoxy group, a 3,4-dimethylphenoxy group, a 2,3,4-trimethylphenoxy group, a 2,3,5-trimethylphenoxy group, a 2,3,6-trimethylphenoxy group, a 2,4,6-trimethylphenoxy group, a 2,4,5-trimethylphenoxy group, a 3,4,5-trimethylphenoxy group, a 2-ethylphenoxy group, a 3-ethylphenoxy group, a 4-ethylphenoxy group, a 2,6-diethylphenoxy group, a 2,5-diethylphenoxy group, a 2,4-diethylphenoxy group, a 3,5-diethylphenoxy group, a 3,4-diethylphenoxy group, a 4-n-propylphenoxy group, a 4-isopropylphenoxy group, a 4-tert-butylphenyoxy group, a 2-methyl-4-tert-butylphenoxy group, a 2-phenylphenoxy group, a 3-phenylphenoxy group, and a 4-phenylphenoxy group; an aryl-substituted phenyoxy group; a naphthyl group; and a naphthyloxy group.

A portion of or all hydrogen atoms of these substituents may be substituted with fluorine and/or a heteroatom-containing group. The heteroatom-containing group is a group that contains a B, N, O, Si, P, or S atom. Examples include groups that contain an amino group, an amide group, an aldehyde group, a glycidyl group, a carboxyl group, a hydroxy group, a cyano group, a mercapto group, or a silyl group.

The compounds described above may be crosslinked by a crosslinking group selected from the group consisting of a phenylene group, a biphenylene group, and a group (19), shown below, with the technique disclosed in WO 00/09518 A1.

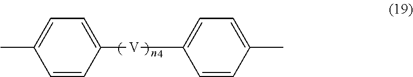

(In formula (19), V represents a group selected from the group consisting of —C(CH₃)₂—, —SO₂—, —S—, and —O—, and n4 represents 0 or 1.)

A phosphazene compound having a crosslinked structure such as described above can specifically be produced by reacting an alkali metal salt of phenol and an alkali metal salt of an aromatic dihydroxy compound with a dichlorophosphazene oligomer. These alkali metal salts are added in slight excess of the theoretical amount relative to the dichlorophosphazene oligomer.

One of such cyclic phosphazene compounds may be used individually, or two or more of such cyclic phosphazene compounds may be used as a mixture.

The cyclic phosphazene compound is a mixture of cyclic trimer and cyclic tetramer structures. From a viewpoint of improving processability, a phosphazene compound containing at least 80 mass % of a cyclic trimer and/or cyclic tetramer compound is preferable, a phosphazene compound containing at least 85 mass % of a cyclic trimer and/or cyclic tetramer compound is more preferable, and a phosphazene compound containing at least 93 mass % of a cyclic trimer and/or cyclic tetramer compound is even more preferable.

In particular, an effect of imparting flame retardance and an effect of improving mechanical properties are excellent when a phosphazene compound is used in the present embodiment that preferably contains at least 70 mass % of a trimer, more preferably contains at least 76 mass % of a trimer, further preferably contains at least 80 mass % of a trimer, and particularly preferably contains at least 85 mass % of a trimer.

The form of the phosphazene compound differs depending on the type of sub stituents and structure thereof, and the phosphazene compound may for example adopt various forms such as a liquid form, a wax form, or a solid form. The phosphazene compound may adopt any form that does not lead to the loss of the effects disclosed herein.

In a situation in which the phosphazene compound is in a solid form, the bulk density of the phosphazene compound is preferably at least 0.45 g/cm³, and more preferably no greater than 0.75 g/cm³.

Alkali metal components such as sodium and potassium that are contained in the cyclic phosphazene compound preferably each have a content of no greater than 200 mass ppm, and more preferably no greater than 50 mass ppm.

It is even more preferable that the total content of all alkali metal components contained in the cyclic phosphazene compound is no greater than 50 mass ppm.

Furthermore, the content of a cyclic phosphazene compound for which at least one of the substituents X in general formula (1) is a hydroxy group (i.e., a cyclic phosphazene compound including a P—OH bond) is preferably less than 1 mass %, and the content of chlorine contained in the cyclic phosphazene compound is preferably no greater than 1,000 mass ppm, more preferably no greater than 500 mass ppm, and further preferably no greater than 300 mass ppm.

The cyclic phosphazene compound in which at least one of the substituents X in general formula (1) is a hydroxy group may adopt an oxo structure represented by general formula (20), shown below. The content of this oxo compound is preferably less than 1 mass % in the same way as for the hydroxy group-containing phosphazene compound.

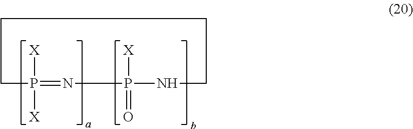

(In formula (20), when a+b=n, n is an integer of at least 3; and each X may, independently of one another, be an aryloxy group or an alkoxy group, and may be the same or different.)

When electrical properties, hydrolysis resistance, and so forth are taken into account, the water content of a cyclic phosphazene compound that can be suitably used in the present embodiment is preferably no greater than 1,000 mass ppm, more preferably no greater than 800 mass ppm, even more preferably no greater than 650 mass ppm, further preferably no greater than 500 mass ppm, and particularly preferably no greater than 300 mass ppm.

An acid value of the cyclic phosphazene compound measured based on JIS K6751 is preferably no greater than 1.0, and more preferably no greater than 0.5.

From a viewpoint of hydrolysis resistance and moisture resistance, the solubility in water (i.e., the amount of a sample that dissolves in distilled water after being mixed with the distilled water in a concentration of 0.1 g/mL and being stirred for 1 hour at room temperature) of a cyclic phosphazene compound that can be suitably used in the present embodiment is preferably no greater than 100 mass ppm, more preferably no greater than 50 mass ppm, and further preferably no greater than 25 mass ppm.

When flame retardance, low fuming during burning, low volatility, and so forth when used in combination with the (A) component are considered, it is preferable that when the cyclic phosphazene compound used in the present embodiment is subjected to TGA measurement in which heating is performed from normal temperature to 600° C. at a heating rate of 10° C./minute in an inert gas atmosphere, the difference between a temperature at which the mass decrease is 50 mass % and a temperature at which the mass decrease is 5 mass % is from 20° C. to 150° C., and more preferably from 20° C. to 120° C. Moreover, in consideration of flame retardance efficiency through the promotion of char layer formation during burning in a situation in which the cyclic phosphazene compound is used with respect to a resin, it is preferable that the temperature at which the mass decrease is 50 mass % is from 320° C. to 500° C., and more preferably from 350° C. to 460° C.

The form of a cyclic phosphazene compound that can be suitably used in the present embodiment differs depending on the type of substituents and structure thereof, and the cyclic phosphazene compound may for example adopt various forms such as a liquid form, a wax form, or a solid form. The cyclic phosphazene compound may adopt any form that does not lead to the loss of the effects disclosed herein. In a situation in which it is necessary to consider handleability, operability, and the like, it is preferable that the cyclic phosphazene compound is in a solid form.

(C-2) Phosphinic Acid Salt

In the present embodiment, (C-2) the phosphinic acid salt that can be used is a phosphinic acid salt represented by general formula (3) or (4), shown below.

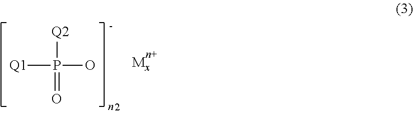

(In formula (3), Q1 and Q2 are each, independently of one another, a substituent selected from the group consisting of a hydrogen atom, an alkyl group having a carbon number of 1-12, an alkoxy group having a carbon number of 1-12, an aryl group, and an aryloxy group; n2 is an integer of 1-3; M is a metal element from period 4 or lower in the periodic table or a protonated nitrogen base, where each M may be the same or different in a situation in which x is 2; and n2=n×x.)

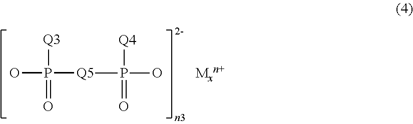

(In formula (4), Q3 and Q4 are each, independently of one another, a substituent selected from the group consisting of a hydrogen atom, an alkyl group having a carbon number of 1-12, an alkoxy group having a carbon number of 1-12, an aryl group, and an aryloxy group; Q5 is a group selected from the group consisting of an alkylene having a carbon number of 1-18, an arylalkylene, an arylene, an alkylarylene, and a diarylene; n3 is an integer of 1-3; x is an integer of 1 or 2; M is a group selected from the group consisting of a metal element from period 4 or lower in the periodic table and a protonated nitrogen base, where each M may be the same or different in a situation in which x is 2; and 2×n3=n×x.)

The phosphinic acid salt used in the present embodiment may be a phosphinic acid salt produced in an aqueous solution using phosphinic acid and a metal carbonate, metal hydroxide, or metal oxide that is essentially a monomeric compound, but that, depending on the reaction conditions, may include a polymeric phosphinic acid salt with a degree of condensation of 1-3 in accordance with the environment.

Examples of the phosphinic acid in general formula (3) and the diphosphinic acid in general formula (4) include dimethylphosphinic acid, ethylmethylphosphinic acid, diethylphosphinic acid, methyl-n-propylphosphinic acid, methane di(methylphosphinic acid), benezene-1,4-(dimethylphosphinic acid), methylphenylphosphinic acid, and diphenylphosphinic acid. Any one of these may be used individually, or any two or more of these may be used together.

No specific limitations are placed on the metal element represented by M in general formulae (3) and (4) other than being a metal element from period 4 or lower in the periodic table. In particular, metal elements from period 4 or lower in the periodic table other than alkali metals such as potassium and cesium are preferable, magnesium calcium, aluminum, tin, germanium, titanium, iron, zirconium, zinc, bismuth, strontium, and manganese are more preferable, and calcium, magnesium, aluminum, titanium, and zinc are particularly preferable.

The metal element is preferably used in the form of a metal carbonate, a metal hydroxide, or a metal oxide that includes the metal element.

Specific examples of phosphinic acid salts that can be used include calcium dimethylphosphinate, magnesium dimethylphosphinate, aluminum dimethylphosphinate, zinc dimethylphosphinate, calcium ethylmethylphosphinate, magnesium ethylmethylphosphinate, aluminum ethylmethylphosphinate, zinc ethylmethylphosphinate, calcium diethylphosphinate, magnesium diethylphosphinate, aluminum diethylphosphinate, zinc diethylphosphinate, titanium diethylphosphinate, calcium methyl-n-propylphosphinate, magnesium methyl-n-propylphosphinate, aluminum methyl-n-propylphosphinate, zinc methyl-n-propylphosphinate, titanium methyl-n-propylphosphinate, calcium methylphenylphosphinate, magnesium methylphenylphosphinate, aluminum methylphenylphosphinate, zinc methylphenylphosphinate, titanium methylphenylphosphinate, calcium diphenylphosphinate, magnesium diphenylphosphinate, aluminum diphenylphosphinate, zinc diphenylphosphinate, titanium diphenylphosphinate, calcium methane di(methylphosphinate), magnesium methane di(methylphosphinate), aluminum methane di(methylphosphinate), zinc methane di(methylphosphinate), titanium methane di(methylphosphinate), calcium benezene-1,4-(dimethylphosphinate), magnesium benezene-1,4-(dimethylphosphinate), aluminum benezene-1,4-(dimethylphosphinate), zinc benezene-1,4-(dimethylphosphinate), and titanium benezene-1,4-(dimethylphosphinate).

In particular, from a viewpoint of flame retardance and electrical properties, aluminum diethylphosphinate and zinc diethylphosphinate are preferable as the phosphinic acid salt.

The particle diameter of the phosphinic acid salt is preferably no greater than 100 μm, and more preferably no greater than 50 μm from a viewpoint of mechanical strength and external appearance of a molded article obtained through molding of the flame-retardant resin composition of the present embodiment. The phosphinic acid salt is preferably used in the form of a powder that has been pulverized to the aforementioned particle diameter. Use of a powder having a particle diameter of from 0.5 μm to 20 μm is particularly preferable in terms that, in addition to a high level of flame retardance being expressed, strength of a molded article is significantly increased.

When the total of the (A) component and the (B) component in the flame-retardant resin composition of the present embodiment is taken to be 100 parts by mass, the total content of the (C-1) component and the (C-2) component described above is preferably from 1 part by mass to 30 parts by mass, and more preferably from 2 parts by mass to 20 parts by mass from a viewpoint of suppressing a decrease in flame retardance after long-term heat aging.

More specifically, when the total of the (A) component and the (B) component is taken to be 100 parts by mass, the content of the (C-1) component in the resin composition is preferably from 1 part by mass to 25 parts by mass, and more preferably from 1 part by mass to 15 parts by mass from a viewpoint of balance of heat resistance and flame retardance, whereas the content of the (C-2) component in the resin composition is preferably from 1 part by mass to 25 parts by mass, and more preferably from 2 parts by mass to 20 parts by mass from a viewpoint of balance of impact resistance and flame retardance.

(D) Antioxidant

Both primary antioxidants that act as radical chain inhibitors and secondary antioxidants that have an effect of breaking down peroxides can be used as (D) an antioxidant in the present embodiment that is present independently in the resin composition without reacting with (A) the polyphenylene ether. In other words, through the use of antioxidants, radicals that may arise at terminal methyl groups and side-chain methyl groups when the polyphenylene ether is exposed to a high temperature for a long time can be captured (primary antioxidant) and peroxides that may arise at terminal methyl groups and side-chain methyl groups due to the aforementioned radicals can be broken down (secondary antioxidant). Consequently, oxidative crosslinking of the polyphenylene ether can be prevented.

Hindered phenol antioxidants can mainly be used as primary antioxidants.

Specific examples of hindered phenol antioxidants that can be used include 2,6-di-tert-butyl-4-methylphenol, pentaerythritol tetraki s[3-(3,5-di-tert-butyl-4-hydroxyphenyl)propionate], n-octadecyl-3-(3,5-di-tert-butyl-4-hydroxyphenyl)propionate, 2,2′-methylenebis(4-methyl-6-tert-butylphenol), 2,6-di-tert-butyl-4-(4,6-bi s(octylthio)-1,3,5-triazin-2-ylamino)phenol, 2-tert-butyl-6-(3-tert-butyl-2-hydroxy-5-methylbenzyl)-4-methylphenyl acrylate, 2-[1-(2-hydroxy-3,5-di-t-pentylphenyl)ethyl]-4,6-di-t-pentylphenyl acrylate, 4,4′-butylidenebi s(3-methyl-6-tert-butylphenol), 4,4′-thiobis(3-methyl-6-tert-butylphenol), alkylated bisphenol, tetrakis [methylene-3-(3,5-di-tert-butyl-4-hydroxyphenyl)propionate]methane, and 3,9-bis[2-{3-(3-tert-butyl-4-hydroxy-5-methylphenyl)-propionyloxy)-1,1-dim ethylethyl]-2,4,8,10-tetraoxyspiro[5,5]undecane.

Phosphorus-containing antioxidants and sulfur-containing antioxidants can mainly be used as secondary antioxidants.

Specific examples of phosphorus-containing antioxidants that can be used include trisnonylphenyl phosphite, triphenyl phosphite, tris(2,4-di-tert-butylphenyl) phosphite, bis(2,4-di-tert-butylphenyl)pentaerythritol-diphosphite, bis(2,6-di-tert-butyl-4-methylphenyl)pentaerythritol-diphosphite, and 3,9-bis(2,6-di-tert-butyl-4-methylphenoxy)-2,4,8,10-tetraoxa-3,9-diphosphasp iro[5,5]undecane.

Specific examples of sulfur-containing antioxidants that can be used include dilauryl 3,3′-thiodipropionate, dimyristyl 3,3′-thiodipropionate, distearyl 3,3′-thiopropionate, pentaerythrityl tetrakis(3-laurylthiopropionate), ditridecyl 3,3′-thiodipropionate, 2-mercaptobenzimidazole, and 2,6-di-tert-butyl-4-(4,6-bis(octylthio)-1,3,5-triazin-2-ylamino)phenol.

Furthermore, examples of other antioxidants that can be used together with the antioxidants described above include metal oxides and sulfides such as zinc oxide, magnesium oxide, and zinc sulfide.

Among the antioxidants described above, secondary antioxidants are effective for improving long-term properties of the polyphenylene ether resin, and among secondary antioxidants, phosphorus-containing antioxidants are preferable.

The content of (D) the antioxidant in the flame-retardant resin composition of the present embodiment when (A) the polyphenylene ether is taken to be 100 parts by mass is preferably from 0.1 parts by mass to 20.0 parts by mass, and is more preferably from 0.1 parts by mass to 5.0 parts by mass from a viewpoint of maintenance of mechanical properties.

In the present embodiment, it is preferable that (D) the antioxidant is present independently in the resin composition without reacting with (A) the polyphenylene ether.

More specifically, in a situation in which the flame-retardant resin composition of the present embodiment is pulverized and dissolved in chloroform and in which methanol is subsequently added, it is preferable that most of the antioxidant contained in the resin composition (for example, at least 90 mol %) elutes into the methanol, which is a good solvent for the antioxidant but a poor solvent for the resin component.

(E) Compatibilizing Agent

In the present embodiment, (E) a compatibilizing agent can be appropriately used in accordance with (B) the thermoplastic resin that is used.

However, a compatibilizing agent in not required in a situation in which a compatible resin is used, such as (B-1) the polystyrene resin.

In a situation in which (B-2) the polyamide resin is used as (B) the thermoplastic resin, at least one compound (E-1) that includes, in a molecular structure thereof, at least one carbon-carbon double or triple bond and at least one carboxyl group, acid anhydride group, amino group, hydroxy group, or glycidyl group, such as described in detail in WO 2001/81473 A1, is preferably used as (E) the compatibilizing agent.

Among such compounds, maleic anhydride, maleic acid, fumaric acid, citric acid, and mixtures thereof are preferable, and maleic acid and/or maleic anhydride is particularly preferable. In particular, in a situation in which maleic acid and/or maleic anhydride is selected as the compatibilizing agent, it is possible to improve added properties of the resin composition such as weld strength.

In a situation in which (E-1) maleic acid and/or maleic anhydride is selected as the compatibilizing agent, the content of the (E) compound in the resin composition relative to 100 parts by mass of (A) the polyphenylene ether is preferably from 0.03 parts by mass to 0.3 parts by mass, more preferably from 0.07 parts by mass to 0.3 parts by mass, and further preferably from 0.1 parts by mass to 0.3 parts by mass.

In a situation in which (B-3) the polypropylene resin is used as (B) the thermoplastic resin, (E-2) a hydrogenated block copolymer having a specific structure can be used as (E) the compatibilizing agent.

The hydrogenated block copolymer is preferably a polymer obtained by hydrogenating a block copolymer including at least two polymer blocks A formed mainly from styrene and at least one polymer block B formed mainly from butadiene having a 1,2-vinyl bond content of from 70% to 90%.

The polymer block B formed mainly from butadiene may be a single polymer block in which the 1,2-vinyl bond content of butadiene prior to hydrogenation is from 70% to 90%.

Furthermore, the polymer block B formed mainly from butadiene may be a combined polymer block formed mainly from butadiene that includes at least one polymer block B1 formed mainly from butadiene having a 1,2-vinyl bond content prior to hydrogenation of from 70% to 90% and at least one polymer block B2 formed mainly from butadiene having a 1,2-vinyl bond content prior to hydrogenation of from 30% to less than 70%. A block copolymer that has a block structure such as described above can for example be expressed as “A-B2-B1-A”, and can be obtained by a commonly known polymerization method in which the 1,2-vinyl bond content is controlled based on the feed sequence of each prepared monomer unit. The bonding format of butadiene prior to hydrogenation can for example be confirmed using an infrared spectrophotometer or an NMR spectrometer.

The content of (E-2) the hydrogenated block copolymer in the resin composition relative to 100 parts by mass in total of (A) the polyphenylene ether and (B-3) the polypropylene resin is preferably from 1 part by mass to 100 parts by mass, more preferably from 1 part by mass to 40 parts by mass, further preferably from 2 parts by mass to 20 parts by mass, and particularly preferably from 2 parts by mass to 10 parts by mass.

In a situation in which (B-4) the polyphenylene sulfide resin is used as (B) the thermoplastic resin, (E) the compatibilizing agent may for example be (E-3) at least one selected from the group consisting of (E-3-1) an epoxy resin, (E-3-2) a silane coupling agent, and (E-3-3) an epoxy group-containing compound and/or an oxazolyl group-containing compound.

Examples of (E-3-3) the epoxy group-containing compound and/or oxazolyl group-containing compound include a copolymer of an unsaturated monomer containing an epoxy group and/or an oxazolyl group and a monomer having styrene as a main component. The monomer having styrene as a main component is of course styrene itself in a situation in which the styrene content thereof is 100 mass %. On the other hand, in a situation in which the aforementioned monomer is a mixture of styrene and another monomer that is copolymerizable therewith, the styrene monomer content is at least 65 mass % and, from a viewpoint of retaining miscibility of the copolymer chain with (A) the polyphenylene ether, the styrene monomer content is more preferably from 75 mass % to 95 mass %. Specific examples include a copolymer of an unsaturated monomer containing an epoxy group and/or an oxazolyl group and a styrene monomer and a copolymer of an unsaturated monomer containing an epoxy group and/or an oxazolyl group and a monomer having styrene as a main component that is composed by from 90 mass % to 75 mass % of styrene and from 10 mass % to 25 mass % of acrylonitrile. Examples of epoxy group-containing unsaturated monomers that can be used include glycidyl methacrylate, glycidyl acrylate, vinyl glycidyl ether, a glycidyl ether of a hydroxyalkyl (meth)acrylate, a glycidyl ether of a polyalkylene glycol (meth)acrylate, and glycidyl itaconate, among which, glycidyl methacrylate is preferable.

One preferable example of an oxazolyl group-containing unsaturated monomer that can be used is 2-isopropenyl-2-oxazoline, which is industrially acquirable.

Examples of other monomers that are copolymerizable with an unsaturated monomer having an epoxy group and/or an oxazolyl group include unsaturated monomers and, more specifically, vinyl acetate, (meth)acrylic acid esters, and vinyl cyanate monomers such as acrylonitrile.

It is important for the (E-3-3) copolymer that the monomer having styrene as a main component, which is copolymerized with the unsaturated monomer containing an epoxy group and/or an oxazolyl group, has a content of at least 65 mass %.

Moreover, in the (E-3-3) copolymer, the content of the unsaturated monomer containing an epoxy group and/or an oxazolyl group is from 0.3 mass % to 20 mass %, preferably from 1 mass % to 15 mass %, and more preferably from 3 mass % to 10 mass %. A content of from 0.3 mass % to 20 mass % of the unsaturated monomer allows good miscibility with (A) the polyphenylene ether and (B-4) the polyphenylene sulfide resin, significantly suppresses the occurrence of burring of a molded article molded from the resultant resin composition, and has an excellent effect on the balance of toughness (impact strength) and rigidity.

Examples of the copolymer of the unsaturated monomer containing an epoxy group and/or an oxazolyl group and the monomer having styrene as a main component include a styrene-glycidyl methacrylate copolymer, a styrene-glycidyl methacrylate-methyl methacrylate copolymer, a styrene-glycidyl methacrylate-acrylonitrile copolymer, a styrene-vinyloxazoline copolymer, and a styrene-vinyloxazoline-acrylonitrile copolymer.

The content of the (E-3) copolymer in the resin composition relative to 100 parts by mass in total of (A) the polyphenylene ether and (B-4) the polyphenylene sulfide resin is preferably from 1 part by mass to 20 parts by mass, more preferably from 2 parts by mass to 15 parts by mass, and further preferably from 3 parts by mass to 10 parts by mass.

In the present embodiment, other materials besides the (A) to (E) components may be added as necessary.

Examples of other materials that can be added include inorganic fillers (for example, talc, kaolin, xonotlite, wollastonite, titanium oxide, potassium titanate, carbon fiber, and glass fiber), commonly known silane coupling agents for improving affinity between inorganic fillers and resins, plasticizers (for example, low molecular weight polyolefins, polyethylene glycol, and fatty acid esters), colorants such as carbon black, conductivity imparting agents such as carbon fiber, conductive carbon black, and carbon fibrils, anti-static agents, various peroxides, ultraviolet absorbers, and light stabilizers.

The following describes important properties of the flame-retardant polyphenylene ether resin composition of the present embodiment.

From a viewpoint of enhancing the effects disclosed herein while maintaining physical properties of the flame-retardant PPE resin composition of the present embodiment, it is preferable that (A) the polyphenylene ether has a content of less than 50 mass % when the flame-retardant resin composition minus ash content, corresponding to a residue obtained upon burning of the flame-retardant resin composition, is taken to be 100 mass %. The upper limit for the aforementioned content may alternatively be set as no greater than 45 mass % or no greater than 40 mass %. The lower limit for the aforementioned content is preferably at least 10 mass %, and may alternatively be set as at least 20 mass % or at least 25 mass %.

The “ash content” is a value calculated by the following method. A sample of approximately 2 g is weighed from a molded article of 12.6 cm in length, 1.3 cm in width, and 1.6 mm in thickness, is placed in a porcelain crucible, and is burnt in an electric furnace for 1 hour at 800° C. After this burning, the porcelain crucible is cooled to room temperature and the amount of residue in the porcelain crucible is taken to be the ash content.

Specifically, the ash content may for example include inorganic fillers such as glass and minerals, metal oxides, and so forth.

Moreover, in the flame-retardant PPE resin composition of the present embodiment, a rate of change in chloroform-insoluble content of the flame-retardant resin composition before and after being subjected to aging in which the flame-retardant resin composition is left for 1,000 hours at 150° C. in an atmospheric environment is no greater than 15 mass %, preferably no greater than 14 mass %, and further preferably no greater than 12 mass %, and is preferably at least 1 mass %, and more preferably at least 5 mass %.

The “rate of change of chloroform-insoluble content” is a value calculated by the following method.

A molded article of 12.6 cm in length, 1.3 cm in width, and 1.6 mm in thickness is prepared. Thereafter, 1) a sample of 1 cm×1 cm×1.6 mm is cut from a bottom edge of the molded article prior to aging, is frozen and pulverized, and is subsequently sieved in order to collect particles that pass through 500 μm openings but not through 355 μm openings. Next, 200 mg of the collected particles are weighed and are ultrasonically vibrated for 6 hours in 40 mL of chloroform. Soluble content and insoluble content are then separated by suction filtration. The resultant residue (insoluble content) is vacuum dried for 2 hours at 100° C. and the mass of the dried residue is measured. The measured value is taken to be the “initial amount of residue”. Thereafter, 2) the molded article is subjected to aging in which the molded article is left for 1,000 hours at 150° C. is then subjected to the same process as described in 1) from cutting of a sample until measurement of the mass of a residue obtained after drying. The measured value is taken to be the “post-aging amount of residue”. The rate of change (%) of insoluble content is calculated from the values obtained in 1) and 2) using formula (X), shown below.

[Post-aging amount of residue (mg)−Initial amount of residue (mg)]/[200−Initial amount of residue (mg)]×100[%] (X)

The flame-retardant resin composition of the present embodiment can be used to produce a molded article.

Although no specific limitations are placed on the method by which the flame-retardant resin composition is molded, suitable examples include injection molding, extrusion molding, vacuum molding, and pressure molding. In particular, injection molding is more preferable from a viewpoint of molding external appearance and brightness.

Specific examples of processing machines that can be used for obtaining the composition used in the molded article of the present embodiment include a single-screw extruder, a twin-screw extruder, a hot press, a roller, a kneader, a Brabender Plastograph, and a Banbury mixer, among which, a twin-screw extruder is preferable.

Although no specific limitations are placed on the temperature of melt-kneading, conditions that enable formation of a suitable composition can be freely selected from a temperature range that is normally from 240° C. to 360° C. when the kneading state and so forth are considered.

### EXAMPLES

The following provides a more specific description of the present disclosure through examples and comparative examples. However, the present disclosure is not in any way limited by the following examples.

First, a description is provided of raw materials of the resin composition that are used in the present embodiment.

(A) Polyphenylene ether (PPE)
(A-1) PPE-1

Poly(2,6-dimethyl-1,4-phenylene ether)

Reduced viscosity=0.42 dL/g (measured by an Ubbelohde viscosity tube at 30° C. using 0.5 g/dL chloroform solution), concentration of terminal OH groups: 0.72
(A-2) PPE-2

Modified polyphenylene ether produced by the method in Production Example 1
(A-3) PPE-3

Modified polyphenylene ether produced by the method in Production Example 2
(A-4) PPE-4

Modified polyphenylene ether produced by the method in Production Example 3
(A-5) PPE-5

Modified polyphenylene ether produced by the method in Production Example 4
(A-6) PPE-6

Modified polyphenylene ether produced by the method in Production Example 5
(A-7) PPE-7

Modified polyphenylene ether produced by the method in Production Example 6
(A-8) PPE-8

Modified polyphenylene ether produced by the method in Production Example 7
(A-9) PPE-9

Modified polyphenylene ether produced by the method in Production Example 8
(A-10) PPE-10

Modified polyphenylene ether produced by the method in Production Example 9

(B) Thermoplastic Resin
(B-1) Polystyrene (GPPS)

Product name: Polystyrene 685, produced by PS Japan Corporation
(B-2) Polyamide 6,6 (PA66)

Product name: Vydyne 48BX, produced by Solutia Inc. (United States of America)
(B-3) Polypropylene Resin (PP)

Product name: NOVATEC PP SA08 Polypropylene, produced by Japan Polypropylene Corporation
(B-4) Polyphenylene Sulfide Resin (PPS)

Product name: TORELINA M2888, produced by Toray Industries, Inc.

(C-1) Cyclic Phosphazene Compound
(C-1-1) Phenoxy cyclophosphazene (product name: FP-110, produced by Fushimi Pharmaceutical Co., Ltd.)
(C-1-2) Cyclic cyanophenoxy phosphazene (product name: FP-300, produced by Fushimi Pharmaceutical Co., Ltd.)

(C-2) Phosphinic Acid Salt

Aluminum phosphinate (product name: Exolit 1230, produced by Clariant)

(D) Antioxidant
(D-1) Chemical name: 3,9-Bis(2,6-di-tert-butyl-4-methylphenoxy)-2,4,8,10-tetraoxa-3,9-diphosphas piro[5,5]undecane (product name: ADK STAB PEP-36® (ADK STAB PEP-36 is a registered trademark in Japan, other countries, or both), produced by ADEKA Corporation)
(D-2) Chemical name: Tris(2,4-di-tert-butylphenyl) phosphite (product name: Irgafos 168® (Irgafos 168 is a registered trademark in Japan, other countries, or both) produced by BASF)

(E) Compatibilizing Agent
(E-1) Maleic anhydride (MAH)

Product name: Maleic anhydride, produced by Mitsubishi Chemical Corporation
(E-2) Hydrogenated block copolymer (SEBS)

Polymer produced by the following method

A commonly known method was used in order to synthesize a block copolymer having a B-A-B-A block structure in which polymer blocks A were formed from polystyrene and polymer blocks B were formed from polybutadiene. A commonly known method was then used to hydrogenate the synthesized block copolymer. Modification of the polymer was not carried out. The resultant unmodified, hydrogenated block copolymer had the following physical properties.

Polystyrene content of block copolymer prior to hydrogenation: 44%

Number average molecular weight (Mn) of block copolymer prior to hydrogenation: 95,000

Number average molecular weight (Mn) of polystyrene blocks: 41,800

Number average molecular weight (Mn) of polybutadiene blocks: 53,200

Molecular weight distribution (Mw/Mn) of block copolymer prior to hydrogenation: 1.06

Total vinyl bond content (1,2-vinyl bond content) of polybutadiene blocks prior to hydrogenation: 75%

Hydrogenation rate of polybutadiene portion composing polybutadiene blocks: 99.9%
(E-3) Styrene-glycidyl methacrylate copolymer containing 5 mass % of glycidyl methacrylate (weight average molecular weight: 110,000)

(X) Flame retardant (flame retardant not included within the scope of (C-1-1) and (C-1-2) components)

Bisphenol A bis(diphenyl phosphate) (BDP) (product name: E890® (E890 is a registered trademark in Japan, other countries, or both), produced by Daihachi Chemical Industry Co., Ltd.)

The following describes an extrusion kneading method.

The (A) to (E) and (X) components of a composition shown in Table 1 were fed from a first feeding inlet of a twin-screw extruder (ZSK-25 produced by Coperion GmbH) and were melt-kneaded to obtain a resin composition in the form of pellets. Note that the twin-screw extruder was set to a barrel temperature of from 270° C. to 320° C. and a screw rotation speed of 300 rpm.

Physical properties of the resultant resin composition were evaluated as described below. The measurement results are shown in Table 1.

[Analysis of PPE Modification]

The content in the modified PPE of the structural units shown in formulae (5) to (7) and (9) to (12) was calculated by ³¹P-NMR, ¹³C-NMR, and ¹H-NMR.

The measurement conditions for NMR were as follows.
³¹P-NMR measurement conditions

Device: JEOL RESONANCE ECS400

Observed nucleus: ³¹P

Observation frequency: 161.8 MHz

Pulse width: 45°

Wait time: 5 secs

Number of integrations: 10,000

Solvent: CDCl₃

Sample concentration: 20 w/v%

Chemical shift standard: 85% phosphoric acid aqueous solution (external standard) 0 ppm
¹³C-NMR measurement conditions

Device: Bruker Biospin Avance 600

Observed nucleus: ¹³C

Observation frequency: 150.9 MHz

Measurement method: Inverse gated decoupling

Pulse width: 30°

Wait time: 10 secs

Number of integrations: 2,000

Solvent: CDCl₃

Sample concentration: 20 w/v%

Chemical shift standard: TMS 0 ppm
¹H-NMR measurement conditions

Device: JEOL ECA 500

Observed nucleus: ¹H

Observation frequency: 500.16 MHz

Measurement method: Single-pulse

Pulse width: 7 μsecs

Wait time: 5 secs

Number of integrations: 512

Solvent: CDCl₃

Sample concentration: 5 w %

Chemical shift standard: TMS 0.00 ppm

[Ash Content]

The ash content of the obtained resin composition was obtained by heating from 2 g to 3 g of resin for 2 hours at 650° C. and calculating the ash content using the following formula.

Ash content (%)=ΔW÷W×100 (ΔW: weight of ash content, W: weight of sample)

In the present examples and modified examples, the ash content was in a range of no greater than 0.1 mass %.

[Rate of Change of Chloroform-Insoluble Content]

A molded article of 12.6 cm in length, 1.3 cm in width, and 1.6 mm in thickness was prepared from the obtained resin composition. Thereafter, 1) a sample of 1 cm×1 cm×1.6 mm was cut from a bottom edge of the molded article prior to aging, was frozen and pulverized, and was subsequently sieved in order to collect particles that passed through 500 μm openings but not through 355 μm openings. Next, 200 mg of the collected particles were weighed and were ultrasonically vibrated for 6 hours in 40 mL of chloroform. Soluble content and insoluble content were then separated by suction filtration. The resultant residue (insoluble content) was vacuum dried for 2 hours at 100° C. and the mass of the dried residue was measured. The measured value was taken to be the “initial amount of residue”. Thereafter, 2) the molded product was subjected to aging treatment in which the molded product was left for 1,000 hours at 150° C. and was then subjected to the same process as described in 1) from cutting of a sample until measurement of the mass of a residue obtained after drying. The measured value was taken to be the “post-aging amount of residue”. The rate of change (%) of insoluble content was calculated from the values obtained in 1) and 2) using formula (X), shown below.

[Post-aging amount of residue (mg)−Initial amount of residue (mg)]/[200−Initial amount of residue (mg)]×100[%] (X)

[Analysis of Atate of Antioxidant in Resin Composition]

For each obtained resin composition that contained an antioxidant, the state of the antioxidant, which was dispersed in liquid form or solid form in the resin, was analyzed.

Specifically, the resin composition was dissolved in chloroform and then an extraction was carried out through addition methanol, which is a good solvent for the antioxidant and a poor solvent for the resin component.

The antioxidant that had been extracted into the methanol was dried and was subsequently measured by ¹H-NMR using deuterated chloroform solvent. The extracted antioxidant was quantified and converted to a percentage (mass %) relative to the amount of the antioxidant contained in the resin composition.

[Flame Retardance]

The resin composition pellets obtained in each example and comparative example were supplied into an inline screw-type injection molding machine set to 290° C. and were injection molded at a mold temperature of 90° C. to form a specimen (2.0 mm in thickness) for a UL 94 vertical burning test. Five specimens molded as described above were used to evaluate flame retardance based on the UL 94 vertical burning test. After a flame had been brought into contact with the specimen for 10 secs, the flame was removed and the burning time until a flame on the specimen was extinguished was taken to be tl (sec). The flame was once again brought into contact with the specimen and was removed after 10 secs. The burning time until a flame on the specimen was extinguished was taken to be t2 (sec). An average burning time (sec) was calculated from 10 measured values for t1 and t2 obtained using the five specimens.

The flame retardance level of these specimens was determined based on the UL 94 standard. In particular, when a flame retardance level of V-0 or higher was determined, the resin composition was determined to be a preferable resin composition.

[Long-Term Flame Retardance]

Specimens (2.0 mm in thickness) for a UL 94 vertical burning test obtained in the same way as described above for testing of flame retardance were hung in a 150° C. Geer oven using clips and were heat aged for 1,000 hours while being rotated such as to be uniformly heated. During the heat aging, the Geer oven had a damper opening setting of 50%. After this heat aging, the specimens were removed from the Geer oven, were evaluated for flame retardance based on a UL 94 vertical burning test, and the average burning time (sec) was calculated from a total of 10 measured values for t1 and t2.

{Production of Polyphenylene Ether (PPE-1)}

A jacketed reaction vessel having a capacity of 10 L and equipped with a stirrer, a thermometer, a condenser, and an oxygen supply tube that extended to the bottom of the reaction vessel was charged with 2 g of copper(II) bromide that was then dissolved in 35 g of di-n-butylamine and 800 g of toluene. A solution of 200 g of 2,6-dimethylphenol dissolved in 500 g of toluene was added to the resultant catalyst solution. The mixed liquid of these solutions was caused to undergo polymerization for 3 hours at 40° C. in the reaction vessel while oxygen was supplied thereto. After the reaction had been terminated, water was brought into contact with the reaction liquid and the catalyst was removed from the reaction liquid to obtain a polyphenylene ether polymerization reaction liquid. The polyphenylene ether reaction liquid was solidified while being continuously stirred in contact with methanol to obtain a polyphenylene ether slurry solution. Wet pulverization of the slurry solution was carried using a 1 mm lattice slit in a Disintegrator (product name) produced by Komatsu Zenoah Co. and solid liquid separation of the pulverized slurry solution was carried out while continuously supplying the pulverized slurry composition into a Young filter-type vacuum filter. The filtered-off solid was dried on the Young filter-type vacuum filter and was then rinse washed with methanol in an amount equivalent to three times the weight of polyphenylene ether. Thereafter, the resultant polyphenylene ether particles were dried. The polyphenylene ether particles in the slurry solution after wet pulverization had a weight average particle diameter of 220 μm and had a content of particles larger than 1,700 μm of 0 mass %.

The poly(2,6-dimethyl-1,4-phenylene ether) (PPE-1) obtained by the production method described above had a reduced viscosity of 0.38 dL/g, a number average molecular weight of 15,300, a terminal OH group concentration of 0.72 groups per 100 units, and a number of dibutylamine terminals per 100 units of 0.43.

The reduced viscosity was measured by an Ubbelohde viscosity tube at 30° C. using a 0.5 g/dL chloroform solution.

### Production Example 1

### Modified Polyphenylene Ether (PPE-2)

A tumbler mixer was used to mix 100 parts by mass of PPE-1 and 1.2 parts by mass of 9,10-dihydro-9-oxa-10-phosphaphenanthrene-10-oxide (produced by Sanko Co., Ltd.). The resultant powder mixture was fed from a first raw material feeding inlet of a twin-screw extruder (ZSK-25 produced by Coperion GmbH) and was melt-kneaded with a barrel temperature of 300° C. and a screw rotation speed of 300 rpm to obtain a resin composition in the form of pellets.

The pellets were dissolved in chloroform and were then reprecipitated using methanol to extract (A) a polyphenylene ether component (PPE-2). Thereafter, vacuum drying was carried out for 4 hours at 60° C. to obtain a powder of (A) the polyphenylene ether (PPE-2).

It was possible to identify (A) the polyphenylene ether (PPE-2) that was obtained by ³¹P-NMR (single pulse method) and ¹H-NMR. The added amount of the reactive compound was obtained by dividing an integral value for a peak appearing at from 2.8 ppm to 3.6 ppm in ¹H-NMR by an integral value for a peak appearing at from 6.0 ppm to 7.0 ppm, which originates from aromatic rings of the polyphenylene ether. It was confirmed that the total number of structures represented by chemical formulae (21) and (22), shown below, that were included per 100 monomer units in the polyphenylene ether chain was 0.25.

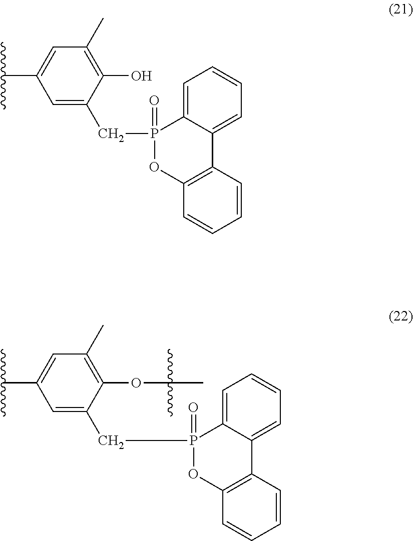

### Production Example 2

### Modified Polyphenylene Ether (PPE-3)

First, a precursor polyphenylene ether having the same units as PPE-1 was produced by the following production method.

A jacketed reaction vessel having a capacity of 10 L and equipped with a stirrer, a thermometer, a condenser, and an oxygen supply tube that extended to the bottom of the reaction vessel was charged with 2.9 kg of xylene, 905 g of methanol, and 1.0 kg (8.2 mol) of 2,6-dimethylphenol and, after a homogeneous liquid had been obtained, a solution of 26.2 g (655 mmol) of sodium hydroxide dissolved in 175 g of methanol was added to the reaction vessel. Next, 20.8 g of a pre-prepared mixture of 810 mg (4.1 mmol) of manganese chloride tetrahydrate and 20 g (328 mmol) of monoethanolamine that had been mixed for 1 hour at 50° C. in a nitrogen atmosphere was added to the reaction vessel. In addition, 20.4 g (329 mmol) of ethylene glycol and 10.6 g (82 mmol) of di-n-butylamine were added to the reaction vessel. The contents of the reaction vessel were caused to react for 3 hours at a maintained reaction temperature of 40° C. while being vigorously stirred and having oxygen blown therein at a rate of 200 Nml/minute. Thereafter, the reaction temperature was lowered to 30° C. and oxygen was blown at a rate of 80 Nml/minute. The supply of oxygen was stopped once 5 hours had passed since initiation of the reaction. Next, 600 mg of the reaction mixture was removed from the reaction vessel and 280 g of methanol was added thereto. Precipitated polymer was suction filtered and was subsequently twice washed with 1 L of methanol and suction filtered. The resultant polymer was dispersed in a solution of 2.9 g of sodium pyrophosphate and 1.9 g of sodium hydrosulfite dissolved in 500 mL of deionized water and was treated for 10 minutes at 80° C. under stirring. A polymer obtained by suction filtration was twice washed with 1 L of deionized water and suction filtered. The wet polymer was dried under reduced pressure for 5 hours at 150° C. to yield 110 g of a polyphenylene ether in powder form.

The precursor polyphenylene ether obtained by the production method described above had the same units as PPE-1, but had a reduced viscosity of 0.47 dL/g and a number of dibutylamine terminals per 100 units of 3.6.

Next, a tumbler mixer was used to mix 100 parts by mass of the precursor polyphenylene ether described above and 1.2 parts by mass of 9,10-dihydro-9-oxa-10-phosphaphenanthrene-10-oxide (produced by Sanko Co., Ltd.). The resultant powder mixture was fed from a first raw material feeding inlet of a twin-screw extruder (ZSK-25 produced by Coperion GmbH) and was melt-kneaded with a barrel temperature of 300° C. and a screw rotation speed of 300 rpm to obtain a resin composition in the form of pellets.

The pellets were dissolved in chloroform and were then reprecipitated using methanol to extract (A) a polyphenylene ether component (PPE-3). Thereafter, vacuum drying was carried out for 4 hours at 60° C. to obtain a powder of (A) the polyphenylene ether (PPE-3).

It was possible to identify (A) the polyphenylene ether (PPE-3) that was obtained by ³¹P-NMR (single pulse method) and ¹H-NMR. The added amount of the reactive compound was obtained by dividing an integral value for a peak appearing at from 2.8 ppm to 3.6 ppm in ¹H-NMR by an integral value for a peak appearing at from 6.0 ppm to 7.0 ppm, which originates from aromatic rings of the polyphenylene ether. It was confirmed that the number of structures represented by chemical formula (20), shown above, that were included per 100 monomer units in the polyphenylene ether chain was 3.4.

### Production Example 3

### Modified Polyphenylene Ether (PPE-4)

A tumbler mixer was used to mix 100 parts by mass of PPE-1 and 1.5 parts by mass of dioctyl phosphonate (produced by Johoku Chemical Co., Ltd.). The resultant powder mixture was fed from a first raw material feeding inlet of a twin-screw extruder (ZSK-25 produced by Coperion GmbH) and was melt-kneaded with a barrel temperature of 300° C. and a screw rotation speed of 300 rpm to obtain a resin composition in the form of pellets.

The pellets were dissolved in chloroform and were then reprecipitated using methanol to extract (A) a polyphenylene ether component (PPE-4). Thereafter, vacuum drying was carried out for 4 hours at 60° C. to obtain a powder of (A) the polyphenylene ether (PPE-4).

It was possible to identify (A) the polyphenylene ether (PPE-4) that was obtained by ³¹P-NMR (single pulse method) and ¹H-NMR. The added amount of the reactive compound was obtained by dividing an integral value for a peak appearing at from 2.8 ppm to 3.6 ppm in ¹H-NMR by an integral value for a peak appearing at from 6.0 ppm to 7.0 ppm, which originates from aromatic rings of the polyphenylene ether. It was confirmed that the total number of structures represented by chemical formulae (23) and (24) that were included per 100 monomer units of the polyphenylene ether was 0.25.

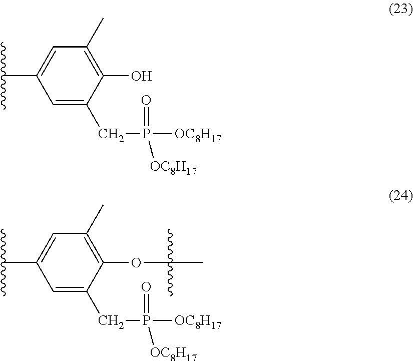

### Production Example 4

### Modified Polyphenylene Ether (PPE-5)

A solution was prepared by dissolving 100 parts by mass of PPE-1, 0.1 parts by mass of N-hydroxyphthalimide (produced by Tokyo Chemical Industry Co., Ltd.), 0.5 parts by mass of triethylamine (produced by Tokyo Chemical Industry Co., Ltd.), and 1.0 parts by mass of methanesulfonyl chloride (produced by Tokyo Chemical Industry Co., Ltd.) in 1 L of chloroform, and was stirred for 5 hours at 60° C. The resultant reaction solution was neutralized with sodium hydrogen carbonate aqueous solution and an organic layer was obtained by carrying out a liquid separation operation. Methanol was gradually added to the resultant organic layer to cause precipitation of a PPE component that was subsequently filtered off and dried to extract (A) a polyphenylene ether component (PPE-5). Thereafter, vacuum drying was carried out for 4 hours at 60° C. to obtain a powder of (A) the polyphenylene ether (PPE-5).

It was possible to identify (A) the polyphenylene ether (PPE-5) that was obtained by ¹H-NMR and ¹³C-NMR. The added amount of the reactive compound was obtained by dividing an integral value for a peak appearing at from 2.8 ppm to 3.6 ppm in ¹H-NMR by an integral value for a peak appearing at from 6.0 ppm to 7.0 ppm, which originates from aromatic rings of the polyphenylene ether. It was confirmed that the total number of structures represented by chemical formulae (25) and (26) that were included per 100 monomer units of the polyphenylene ether was 0.3.

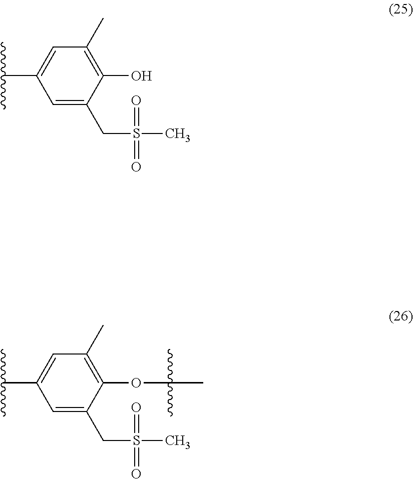

### Production Example 5

### Modified Polyphenylene Ether (PPE-6)

A tumbler mixer was used to mix 100 parts by mass of PPE-1 and 1.6 parts by mass of stearyl acrylate (produced by Tokyo Chemical Industry Co., Ltd.). The resultant powder mixture was fed from a first raw material feeding inlet of a twin-screw extruder (ZSK-25 produced by Coperion GmbH) and was melt-kneaded with a barrel temperature of 300° C. and a screw rotation speed of 300 rpm to obtain a resin composition in the form of pellets.

The pellets were dissolved in chloroform, and purified water was subsequently added thereto. A water layer and an organic layer were separated by a liquid separation operation and the organic layer was collected. A PPE component was reprecipitated from the organic layer using methanol to extract the polyphenylene ether component (PPE-6). Thereafter, vacuum drying was carried out for 4 hours at 60° C. to obtain a powder of PPE-6.

It was possible to identify the resultant PPE-6 by ¹H-NMR. It was confirmed that the number of structures represented by chemical formula (27) that were included per 100 monomer units of the polyphenylene ether was 0.4 by dividing an integral value for a peak appearing at from 2.5 ppm to 4.0 ppm in ¹H-NMR by an integral value for a peak appearing at from 6.0 ppm to 7.0 ppm, which originates from aromatic rings of the polyphenylene ether.

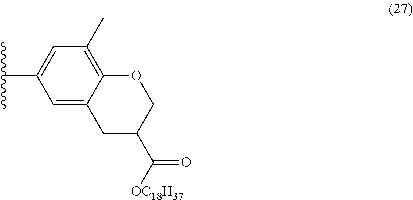

### Production Example 6

### Modified Polyphenylene Ether (PPE-7)

A tumbler mixer was used to mix 100 parts by mass of PPE-1 and 10 parts by mass of styrene. The resultant powder mixture was fed from a first raw material feeding inlet of a twin-screw extruder (ZSK-25 produced by Coperion GmbH) and was melt-kneaded with a barrel temperature of 300° C. and a screw rotation speed of 300 rpm to obtain a resin composition in the form of pellets.

The pellets were dissolved in chloroform and were then reprecipitated using methanol to extract a polyphenylene ether component. Thereafter, vacuum drying was carried out for 4 hours at 60° C. to obtain a powder of PPE-7.

It was possible to identify the resultant PPE-7 by ¹H-NMR. It was confirmed that the number of structures represented by chemical formula (28) that were included per 100 monomer units of the polyphenylene ether was 0.4 by dividing an integral value for a peak appearing at from 2.5 ppm to 4.0 ppm in ¹H-NMR by an integral value for a peak appearing at from 6.0 ppm to 7.0 ppm, which originates from aromatic rings of the polyphenylene ether.

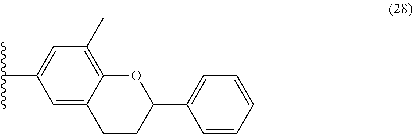

### Production Example 7

### Modified Polyphenylene Ether (PPE-8)

A tumbler mixer was used to mix 100 parts by mass of PPE-1 and 5.0 parts by mass of maleic anhydride. The resultant powder mixture was fed from a first raw material feeding inlet of a twin-screw extruder (ZSK-25 produced by Coperion GmbH) and was melt-kneaded with a barrel temperature of 300° C. and a screw rotation speed of 300 rpm to obtain a resin composition in the form of pellets.

The pellets were dissolved in chloroform and were then reprecipitated using methanol to extract a modified polyphenylene ether component. Thereafter, vacuum drying was carried out for 4 hours at 60° C. to obtain a powder of PPE-8.

It was possible to identify the resultant PPE-8 by ¹H-NMR. It was confirmed that the number of structures represented by chemical formula (29) that were included per 100 monomer units of the polyphenylene ether was 0.3 by dividing an integral value for a peak appearing at from 2.5 ppm to 4.0 ppm in ¹H-NMR by an integral value for a peak appearing at from 6.0 ppm to 7.0 ppm, which originates from aromatic rings of the polyphenylene ether.

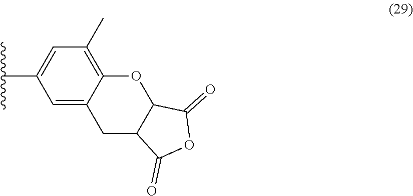

### Production Example 8

### Modified Polyphenylene Ether (PPE-9)

A tumbler mixer was used to mix 100 parts by mass of PPE-1 and 0.8 parts by mass of isonicotinic acid (produced by Tokyo Chemical Industry Co., Ltd.). The resultant powder mixture was fed from a first raw material feeding inlet of a twin-screw extruder (ZSK-25 produced by Coperion GmbH) and was melt-kneaded with a barrel temperature of 300° C. and a screw rotation speed of 300 rpm to obtain a resin composition in the form of pellets.

The pellets were dissolved in chloroform, and purified water was subsequently added thereto. A water layer and an organic layer were separated by a liquid separation operation and the organic layer was collected. A PPE component was reprecipitated from the organic layer using methanol to extract a modified polyphenylene ether component (PPE-9). Thereafter, vacuum drying was carried out for 4 hours at 60° C. to obtain a powder of PPE-9.

It was possible to identify the resultant PPE-9 by ³¹P-NMR and ¹³C-NMR (quantitative method). It was confirmed that the number of structures represented by chemical formula (30) that were included per 100 monomer units of the polyphenylene ether was 0.3.

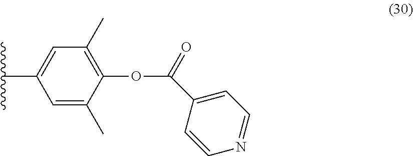

### Production Example 9

### Modified Polyphenylene Ether (PPE-10)

First, 3 L of toluene solvent, 300 g of PPE-1, and 0.3 g of benezenesulfonyl chloride were measured into a reaction vessel (10 L) purged with nitrogen and were refluxed for 4 hours while being stirred.

Next, 3 L of methanol was gradually added to the resultant solution to cause reprecipitation of a polymer component. Thereafter, filtration was carried out, and the filtered-off powder was sufficiently washed with methanol and was subsequently vacuum dried to obtain a powder of PPE-10.

It was possible to identify the resultant PPE-10 by ¹H-NMR and ¹³C-NMR (quantitative method). It was confirmed that the number of structures represented by chemical formula (31) that were included per 100 monomer units of the polyphenylene ether was 0.4.

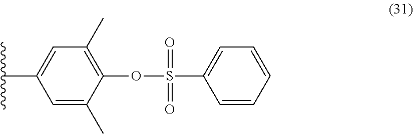

Detailed conditions, measurement results, and evaluation results for Examples 1-21 and Comparative Examples 1-6 are shown in Table 1.

TABLE 1

| | | | | | | Com- | Com- | Com- | Com- | Com- | Com- | | | | | | |
|---|---|---|---|---|---|---|---|---|---|---|---|---|---|---|---|---|---|
| | | | | | | parative | parative | parative | parative | parative | parative | | | | | | |
| | | | | | | Exam- | Exam- | Exam- | Exam- | Exam- | Exam- | Exam- | Exam- | Exam- | Exam- | Exam- | Exam- |
| | | | | | | ple 1 | ple 2 | ple 3 | ple 4 | ple 5 | ple 6 | ple 1 | ple 2 | ple 3 | ple 4 | ple 5 | ple 6 |
| Flame-retardant | First raw material | Polyphenylene | A-1 | PPE-1 | Parts by mass | 80 | 60 | 80 | 45 | 45 | 45 | 45 | 45 | 45 | 45 | 30 | 10 |
| resin | feeding inlet | ether | A-2 | PPE-2 | Parts by mass | | | | | | | | | | | | |
| composition and | | | A-3 | PPE-3 | Parts by mass | | | | | | | | | | | | |
| production | | | A-4 | PPE-4 | Parts by mass | | | | | | | | | | | | |
| method thereof | | | A-5 | PPE-5 | Parts by mass | | | | | | | | | | | | |
| | | | A-6 | PPE-6 | Parts by mass | | | | | | | | | | | | |
| | | | A-7 | PPE-7 | Parts by mass | | | | | | | | | | | | |
| | | | A-8 | PPE-8 | Parts by mass | | | | | | | | | | | | |
| | | | A-9 | PPE-9 | Parts by mass | | | | | | | | | | | | |
| | | | A-10 | PPE-10 | Parts by mass | | | | | | | | | | | | |
| | | Thermoplastic | B-1 | GPPS | Parts by mass | 20 | 40 | 40 | 55 | 55 | 55 | 55 | 55 | 55 | 55 | 70 | 90 |
| | | resin | B-3 | PP | Parts by mass | | | | | | | | | | | | |
| | | | B-4 | PPS | Parts by mass | | | | | | | | | | | | |
| | | Flame retardant | C-1-1 | FP-110 | Parts by mass | 7.5 | 7.5 | 7.5 | | 7.5 | | 7.5 | | 7.5 | 7.5 | 11 | 15 |
| | | | C-1-2 | FP-300 | Parts by mass | | | | | | | | 7.5 | | | | |
| | | | C-2 | Exolit 1230 | Parts by mass | 4.5 | 4.5 | 4.5 | | | 4.5 | 4.5 | 4.5 | 4.5 | 4.5 | 7.5 | 10 |
| | | Antioxidant | D-1 | PEP-36 | Parts by mass | | | 3 | | | | | | 3 | | | |
| | | | D-2 | Irgafos 168 | Parts by mass | | | | | | | | | | 3 | | |
| | | Compatibilizing | E-1 | MAH | Parts by mass | | | | | | | | | | | | |
| | | agent | E-2 | SEBS | Parts by mass | | | | | | | | | | | | |
| | | | E-3 | Copolymer | Parts by mass | | | | | | | | | | | | |
| | Second raw | Thermoplastic | B-2 | PA | Parts by mass | | | | | | | | | | | | |
| | material feeding | resin | B-3 | PP | Parts by mass | | | | | | | | | | | | |
| | inlet | | | | | | | | | | | | | | | | |
| | Liquid addition | Flame retardant | X | BDP | Parts by mass | | | | 25 | 10 | 10 | | | | | | |
| | pump | | | | | | | | | | | | | | | | |

| Evaluation | Rate of change of insoluble content before and after 1,000 | | Mass % | 45 | 28 | 30 | 9 | 13 | 11 | 12 | 14 | 9 | 8 | 5 | 3 |
|---|---|---|---|---|---|---|---|---|---|---|---|---|---|---|---|
| | hours of aging at 150° C. | | | | | | | | | | | | | | |
| | State of antioxidant in resin composition | | Mass % | — | — | 95 | — | — | — | — | — | 94 | 95 | — | — |
| | (percentage of antioxidant extracted) | | | | | | | | | | | | | | |
| | Flame retardance (UL 94, 2.0 mm) | Average | Sec | 1.8 | 3.5 | 2.0 | Drip- | 6.0 | 7.2 | 3.6 | 4.0 | 3.7 | 3.5 | 4.0 | 4.5 |
| | | burn time | | | | | ping | | | | | | | | |
| | | Flame | — | V-0 | V-0 | V-0 | V-2 | V-1 | V-1 | V-0 | V-0 | V-0 | V-0 | V-0 | V-0 |
| | | retardance | | | | | | | | | | | | | |
| | | level | | | | | | | | | | | | | |
| | Long-term flame retardance | Average | Sec | 30.2 | 23.5 | 42.3 | 8.0 | 22.5 | 16.3 | 5.0 | 4.8 | 4.2 | 4.5 | 4.0 | 4.0 |
| | (UL 94, 2.0 mm) | burn time | | | | | | | | | | | | | |
| | (after 1,000 hours of aging at 150° C.) | | | | | | | | | | | | | | |

| | | | | | | | | | | | | Ex- | Ex- | Ex- | Ex- | Ex- | Ex- | Ex- | Ex- | Ex- |
|---|---|---|---|---|---|---|---|---|---|---|---|---|---|---|---|---|---|---|---|---|
| | | | | | | | | | | | | am- | am- | am- | am- | am- | am- | am- | am- | am- |
| | | | | | | Exam- | Exam- | Exam- | Exam- | Exam- | Exam- | ple | ple | ple | ple | ple | ple | ple | ple | ple |
| | | | | | | ple 7 | ple 8 | ple 9 | ple 10 | ple 11 | ple 12 | 13 | 14 | 15 | 16 | 17 | 18 | 19 | 20 | 21 |
| Flame-retardant | First raw | Polyphenylene | A-1 | PPE-1 | Parts by mass | | | | | | | | | | 45 | | 45 | | 45 | |
| resin | material feeding | ether | A-2 | PPE-2 | Parts by mass | 45 | | | | | | | | | | 45 | | 45 | | 45 |
| composition and | inlet | | A-3 | PPE-3 | Parts by mass | | 45 | | | | | | | | | | | | | |
| production | | | A-4 | PPE-4 | Parts by mass | | | 45 | | | | | | | | | | | | |
| method thereof | | | A-5 | PPE-5 | Parts by mass | | | | 45 | | | | | | | | | | | |
| | | | A-6 | PPE-6 | Parts by mass | | | | | 45 | | | | | | | | | | |
| | | | A-7 | PPE-7 | Parts by mass | | | | | | 45 | | | | | | | | | |
| | | | A-8 | PPE-8 | Parts by mass | | | | | | | 45 | | | | | | | | |
| | | | A-9 | PPE-9 | Parts by mass | | | | | | | | 45 | | | | | | | |
| | | | A-10 | PPE-10 | Parts by mass | | | | | | | | | 45 | | | | | | |
| | | Thermoplastic | B-1 | GPPS | Parts by mass | 55 | 55 | 55 | 55 | 55 | 55 | 55 | 55 | 55 | | | | | | |
| | | resin | B-3 | PP | Parts by mass | | | | | | | | | | | | 20 | 20 | | |
| | | | B-4 | PPS | Parts by mass | | | | | | | | | | | | | | 55 | 55 |
| | | Flame retardant | C-1-1 | FP-110 | Parts by mass | 7.5 | 7.5 | 7.5 | 7.5 | 7.5 | 7.5 | 7.5 | 7.5 | 7.5 | 1 | 1 | 2 | 2 | 2.5 | 2.5 |
| | | | C-1-2 | FP-300 | Parts by mass | | | | | | | | | | | | | | | |
| | | | C-2 | Exolit 1230 | Parts by mass | 4.5 | 4.5 | 4.5 | 4.5 | 4.5 | 4.5 | 4.5 | 4.5 | 4.5 | 4 | 4 | 8 | 8 | 5 | 5 |
| | | Antioxidant | D-1 | PEP-36 | Parts by mass | | | | | | | | | | | | | | | |
| | | | D-2 | Irgafos 168 | Parts by mass | | | | | | | | | | | | | | | |
| | | Compatibilizing | E-1 | MAH | Parts by mass | | | | | | | | | | 0.1 | 0.1 | | | | |
| | | agent | E-2 | SEBS | Parts by mass | | | | | | | | | | | | 10 | 10 | | |
| | | | E-3 | Copolymer | Parts by mass | | | | | | | | | | | | | | 4 | 4 |
| | Second raw | Thermoplastic | B-2 | PA | Parts by mass | | | | | | | | | | 55 | 55 | | | | |
| | material feeding | resin | B-3 | PP | Parts by mass | | | | | | | | | | | | 35 | 35 | | |
| | inlet | | | | | | | | | | | | | | | | | | | |
| | Liquid addition | Flame retardant | X | BDP | Parts by mass | | | | | | | | | | | | | | | |
| | pump | | | | | | | | | | | | | | | | | | | |

| Evaluation | Rate of change of insoluble content before and after 1,000 | | Mass % | 7 | 4 | 7 | 10 | 11 | 11 | 15 | 15 | 15 | 14 | 14 | 14 | 14 | 15 | 15 |
|---|---|---|---|---|---|---|---|---|---|---|---|---|---|---|---|---|---|---|
| | hours of aging at 150° C. | | | | | | | | | | | | | | | | | |
| | State of antioxidant in resin composition | | Mass % | — | — | — | — | — | — | — | — | — | — | — | — | — | — | — |
| | (percentage of antioxidant extracted) | | | | | | | | | | | | | | | | | |
| | Flame retardance (UL 94, 2.0 mm) | Average | Sec | 3.3 | 3.0 | 3.3 | 4.0 | 4.0 | 4.5 | 4.4 | 3.6 | 3.8 | 3.8 | 3.6 | 4.6 | 4.3 | 4.3 | 4.0 |
| | | burn time | | | | | | | | | | | | | | | | |
| | | Flame | — | V-0 | V-0 | V-0 | V-0 | V-0 | V-0 | V-0 | V-0 | V-0 | V-0 | V-0 | V-0 | V-0 | V-0 | V-0 |
| | | retardance | | | | | | | | | | | | | | | | |
| | | level | | | | | | | | | | | | | | | | |
| | Long-term flame retardance | Average | Sec | 4.0 | 3.5 | 4.0 | 4.8 | 4.8 | 4.9 | 4.9 | 4.8 | 4.7 | 4.8 | 4.6 | 4.9 | 4.3 | 4.7 | 4.0 |
| | (UL 94, 2.0 mm) | burn time | | | | | | | | | | | | | | | | |
| | (after 1,000 hours of aging at 150° C.) | | | | | | | | | | | | | | | | | |

### INDUSTRIAL APPLICABILITY

According to the present disclosure, it is possible to achieve a flame-retardant polyphenylene ether resin composition that has both excellent flame retardance and excellent long-term flame retardance, and it is possible to provide a thermoplastic resin molded article that is applicable for electric and electronic components, vehicle components, and so forth that are required to exhibit a high level of resistance to heat aging.

1. A flame-retardant resin composition comprising:
(A) a polyphenylene ether;
(B) at least one thermoplastic resin selected from the group consisting of (B-1) a polystyrene resin, (B-2) a polyamide resin, (B-3) a polypropylene resin, and (B-4) a polyphenylene sulfide resin; and
(C) a flame retardant, wherein
the (A) component has a content of less than 50 mass % when the flame-retardant resin composition minus ash content, corresponding to a residue obtained upon burning of the flame-retardant resin composition, is taken to be 100 mass %,
the flame-retardant resin composition has a flame retardance level of V-0 as measured by a UL 94 vertical burning test using a specimen of 2.0 mm in thickness, and
a molded article of 12.6 cm in length, 1.3 cm in width, and 1.6 mm in thickness formed from the flame-retardant resin composition exhibits a rate of change of chloroform-insoluble content of no greater than 15 mass % before and after being subjected to aging in which the molded article is left for 1,000 hours at 150° C. in an atmospheric environment.

2. The flame-retardant resin composition of claim 1, wherein
the (C) component includes (C-1) a cyclic phosphazene compound represented by chemical formula (1), shown below, and (C-2) a phosphinic acid salt represented by chemical formula (3), shown below, or chemical formula (4), shown below, 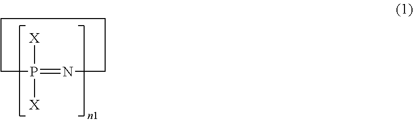
in chemical formula (1): n1 is an integer of 3-25; and X is a substituent selected from the group consisting of an alkyl group having a carbon number of 1-6, an aryl group having a carbon number of 6-11, a fluorine atom, an aryloxy group represented by general formula (2), shown below, a naphthyloxy group, an alkoxy group having a carbon number of 1-6, and an alkoxy-substituted alkoxy group, where each X may be the same or different to one another, and a portion of or all hydrogen atoms on the substituent represented by X may be substituted with a group selected from the group consisting of a fluorine atom, a hydroxy group, and a cyano group, 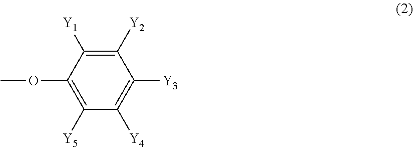
in general formula (2), Y₁, Y₂, Y₃, Y₄, and Y₅ are each, independently of one another, a sub stituent selected from the group consisting of a hydrogen atom, a fluorine atom, an alkyl group having a carbon number of 1-5, an alkoxy group having a carbon number of 1-5, a phenyl group, and a heteroatom-containing group, 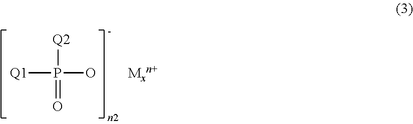
in chemical formula (3): Q1 and Q2 are each, independently of one another, a substituent selected from the group consisting of a hydrogen atom, an alkyl group having a carbon number of 1-12, an alkoxy group having a carbon number of 1-12, an aryl group, and an aryloxy group; n2 is an integer of 1-3; M is a metal element from period 4 or lower in the periodic table or a protonated nitrogen base, where each M may be the same or different in a situation in which x is 2; and n2=n×x, and 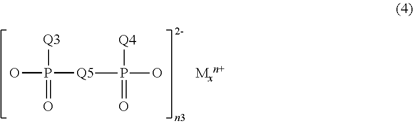
in chemical formula (4): Q3 and Q4 are each, independently of one another, a substituent selected from the group consisting of a hydrogen atom, an alkyl group having a carbon number of 1-12, an alkoxy group having a carbon number of 1-12, an aryl group, and an aryloxy group; Q5 is a group selected from the group consisting of an alkylene having a carbon number of 1-18, an arylalkylene, an arylene, an alkylarylene, and a diarylene; n3 is an integer of 1-3; x is an integer of 1 or 2; M is a group selected from the group consisting of a metal element from period 4 or lower in the periodic table and a protonated nitrogen base, where each M may be the same or different in a situation in which x is 2; and 2×n3=n×x.

3. The flame-retardant resin composition of claim 1, wherein
the (C-1) component and the (C-2) component have a total content of from 1 part by mass to 30 parts by mass when a total of the (A) component and the (B) component is taken to be 100 parts by mass.

4. The flame-retardant resin composition of claim 1, further comprising
(D) an antioxidant, wherein
the (D) component is present independently in the flame-retardant resin composition without reacting with a polyphenylene ether, and
the (D) component has a content of from 0.1 parts by mass to 20.0 parts by mass when the (A) component is taken to be 100 parts by mass.

5. The flame-retardant resin composition of claim 4, wherein
the (D) component includes a phosphorus-containing antioxidant.

6. The flame-retardant resin composition of claim 1, wherein
the (A) component includes at least one structural unit selected from the group consisting of chemical formulae (5), (6), (7), (9), (10), (11), and (12), shown below, 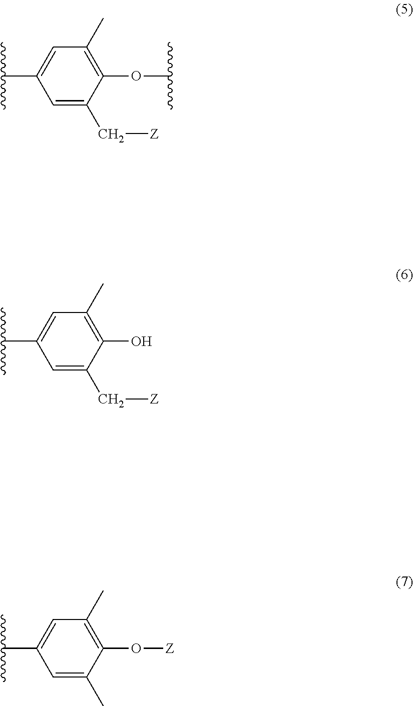
Z in chemical formulae (5), (6), and (7) is a group selected from groups shown in chemical formula (8), 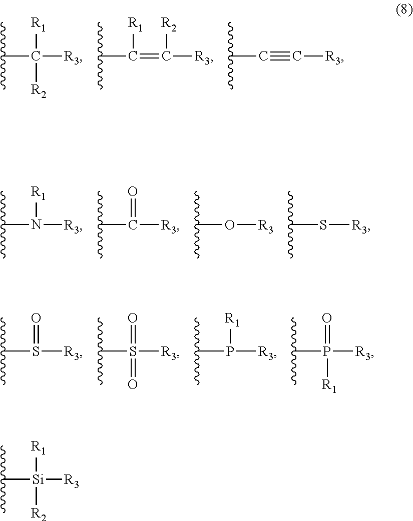
where, in chemical formula (8), R₁ to R₃ are each, independently of one another, a group selected from the group consisting of a hydrogen atom, an alkyl group, an aryl group, a hydroxy group, an alkoxy group, a carbonyl group, an amino group, and an amide group, and R₁ to R₃ may form a cyclic structure through bonding between atoms included therein, 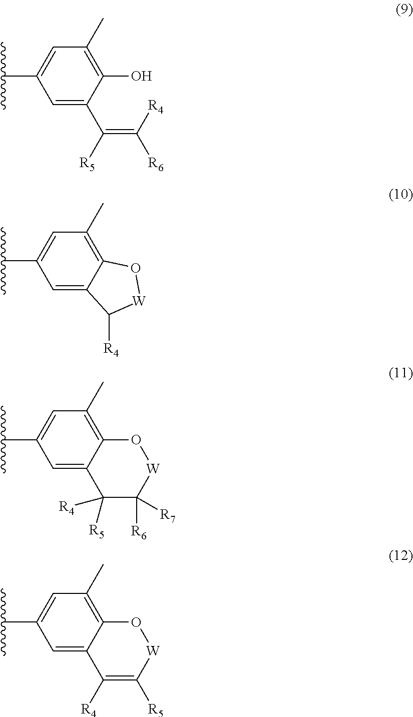
R₄ to R₇ in chemical formulae (9), (10), (11), and (12) are each, independently of one another, a group selected from the group consisting of a hydrogen atom, an alkyl group, an aryl group, a hydroxy group, an alkoxy group, a carbonyl group, an amino group, and an amide group,
W in chemical formulae (10), (11), and (12) is a group selected from structures shown in chemical formula (13), 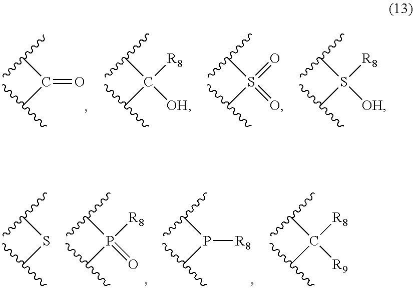
where, in chemical formula (13), R₈ and R₉ are each, independently of one another, a group selected from the group consisting of a hydrogen atom, an alkyl group, an aryl group, a hydroxy group, an alkoxy group, a carbonyl group, an amino group, and an amide group, and
R₆ or R₇ in chemical formulae (10), (11), and (12) and R₈ or R₉ in chemical formula (13) may form a cyclic structure through bonding between atoms included therein.

7. The flame-retardant resin composition of claim 6, wherein
a structural unit shown in any one of chemical formulae (5), (6), (7), (9), (10), (11), and (12) is contained in an amount of from 0.1 units to 10 units per 100 monomer units forming the (A) component.

8. The flame-retardant resin composition of claim 2, wherein
the (C-1) component and the (C-2) component have a total content of from 1 part by mass to 30 parts by mass when a total of the (A) component and the (B) component is taken to be 100 parts by mass.

9. The flame-retardant resin composition of claim 2, further comprising
(D) an antioxidant, wherein
the (D) component is present independently in the flame-retardant resin composition without reacting with a polyphenylene ether, and
the (D) component has a content of from 0.1 parts by mass to 20.0 parts by mass when the (A) component is taken to be 100 parts by mass.

10. The flame-retardant resin composition of claim 3, further comprising
(D) an antioxidant, wherein
the (D) component is present independently in the flame-retardant resin composition without reacting with a polyphenylene ether, and
the (D) component has a content of from 0.1 parts by mass to 20.0 parts by mass when the (A) component is taken to be 100 parts by mass.
